(19) United States
(12) Patent Application Publication
(10) Pub. No.: US 2011/0007957 A1
(43) Pub. Date: Jan. 13, 2011

(54) IMAGING APPARATUS AND CONTROL METHOD THEREFOR

(75) Inventor: Yukio Sakagawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/830,980

(22) Filed: Jul. 6, 2010

(30) Foreign Application Priority Data
Jul. 9, 2009 (JP) 2009-162964

(51) Int. Cl. G06T 7/00; G01B 11/02

(52) U.S. Cl. 382/131; 356/497

(57) ABSTRACT

An imaging apparatus that captures a tomographic image of a subject includes: a first tomographic image acquisition unit to acquire a first tomographic image of the subject, a tomographic image analysis unit to analyze the first tomographic image, an image capturing parameter setting unit to set an image capturing parameter for capturing a second tomographic image of the subject according to a result of analysis by the tomographic image analysis unit, a second tomographic image acquisition unit to acquire the second tomographic image captured according to the image capturing parameter set by the image capturing parameter setting unit, and a correction unit to correct positional deviation of the first tomographic image by using the second tomographic image.

### BACKGROUND OF THE INVENTION

1. Field of the Invention

The present invention relates to an imaging apparatus configured to capture a tomographic image of a subject, a control method therefor, and a computer-readable storage medium storing a program that causes a computer to execute the control method.

2. Description of the Related Art

Conventionally, in order to perform an early diagnosis of various lifestyle-related diseases or other diseases that are primary causes of blindness, an opthalmological examination has been widely performed on the eyes of a person by taking an image thereof as a subject.

In executing such a medical examination, it is necessary for a medical practitioner (e.g., a doctor) or an imaging technician to examine thoroughly the entire eyes of a subject person to accurately identify a disease or illness, if any. Accordingly, in most cases, it is necessary to perform an examination by using an image of a wide area of the eyes (hereinafter referred to as a “fundus wide area image”).

A fundus wide area image can be captured by using a fundus camera or a scanning laser opthalmoscope (SLO). A fundus camera includes a microscope with an attached camera designed to photograph the interior surface of the eye. An SLO is an instrument for retinal imaging in which the interior of the eye is scanned by a low-power laser, and the reflected light is used to create a digital image. An apparatus that acquires a tomographic image of the eyes, which uses optical coherence tomography (OCT), is capable of three-dimensionally observing a state of the inside of a layer of retina of the eye. Specifically, OCT is an interferometric imaging technique that provides cross-sectional views of the subsurface microstructure of biological tissue. Accordingly, a tomographic image acquisition apparatus that can perform OCT is considered particularly useful in appropriately performing a diagnosis of diseases.

However, the eyes of a person show a subconscious continuous minute movement, i.e., an involuntary eye movement, when the person is looking at a specific same point for certain period of time. In capturing an image of the eye by using an OCT apparatus, it takes some time from the start of the imaging operation to the end thereof. Accordingly, if the eye of the examined subject (subject's eye) shows an unexpected abrupt movement, displacement or distortion may occur on a resulting captured image.

FIG. 24A illustrates an example of a tomographic image capturing position observed from a point of view of a tomographic image acquisition apparatus. FIG. 24B illustrates an example of a tomographic image capturing position on the retina of a subject's eye.

Referring to FIG. 24A, an image capturing position 2410 is an example of a tomographic image capturing position observed from a point of view of a tomographic image acquisition apparatus. Each line of the image capturing position 2410 corresponds to a tomographic image captured by using an OCT.

However, during an actual examination, the eyeball may move due to the above-described phenomenon of involuntary eye movement. Accordingly, as illustrated in FIG. 24B, a scanning line for scanning in a tomographic image capturing position 2420 on the retina of the subject's eye may be different from the scanning line of the image capturing position 2410 illustrated in FIG. 24A.

In order to address the above-described problem, a conventional method reduces distortion of data having a three-dimensional shape by correcting positional deviation occurring among tomographic images. Japanese Patent Application Laid-Open No. 2007-130403 discusses a method for correcting positional deviation occurring among two or more tomographic images by using a reference image (a single tomographic image or fundus image perpendicular to two or more tomographic images).

However, the method discussed in Japanese Patent Application Laid-Open No. 2007-130403 merely acquires a reference image while the position of scanning by a scanner is returned to the origin.

The retina of a subject's eye is basically layered. Furthermore, a reference image obtained by using the method discussed in Japanese Patent Application Laid-Open No. 2007-130403 does not always include an amount of characteristics large enough to correct image deviation. Accordingly, it is difficult for the method discussed in Japanese Patent Application Laid-Open No. 2007-130403 to correct positional deviation of image with high accuracy.

Japanese Patent Application Laid-Open No. 2007-130403 also discuses a method for correcting a position of a tomographic image by using a fundus image. However, it is difficult for the above-described conventional method to correctly align the position of an image in the direction of depth, i.e., in a direction perpendicular to the retina.

### SUMMARY OF THE INVENTION

The present invention is directed to a method for highly accurately correcting image deviation of a tomographic image of a subject.

According to an aspect of the present invention, an imaging apparatus configured to capture a tomographic image of a subject includes a first tomographic image acquisition unit configured to acquire a first tomographic image of the subject, a tomographic image analysis unit configured to analyze the first tomographic image, an image capturing parameter setting unit configured to set an image capturing parameter for capturing a second tomographic image of the subject according to a result of analysis by the tomographic image analysis unit, a second tomographic image acquisition unit configured to acquire the second tomographic image captured according to the image capturing parameter set by the image capturing parameter setting unit, and a correction unit configured to correct positional deviation of the first tomographic image by using the second tomographic image.

Further features and aspects of the present invention will become apparent to persons of ordinary skill in the art from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary configuration of an imaging system including an imaging apparatus according to a first exemplary embodiment of the present invention.

FIG. 2 illustrates an exemplary hardware configuration of the imaging apparatus according to the first exemplary embodiment of the present invention.

FIG. 3 illustrates an exemplary functional configuration of the imaging apparatus according to the first exemplary embodiment of the present invention.

FIG. 4 illustrates an exemplary inner configuration of a tomographic image acquisition unit illustrated in FIG. 3.

FIG. 5 illustrates an example of a tomographic image acquired by the tomographic image acquisition unit (image reconstruction unit) illustrated in FIG. 4.

FIG. 6 is a flow chart illustrating an example of processing executed in a control method for controlling the imaging apparatus according to the first exemplary embodiment of the present invention.

FIG. 7 is a flow chart illustrating an example of processing for setting a reference tomographic image capturing parameter, which is executed in step S630 illustrated in FIG. 6, according to the first exemplary embodiment of the present invention.

FIGS. 8A through 8D illustrate an example of a positional relationship between a three-dimensional tomographic image of interest and a reference tomographic image, which is calculated based on a result of extracting a characteristic amount of the three-dimensional tomographic image of interest according to the first exemplary embodiment of the present invention.

FIG. 9 is a flow chart illustrating an example of processing for correcting positional deviation of a tomographic image of interest, which is executed in step S650 illustrated in FIG. 6, according to the first exemplary embodiment of the present invention.

FIG. 10 illustrates an example of a result of the processing in step S650 illustrated in FIG. 6 according to the first exemplary embodiment of the present invention.

FIG. 11 illustrates an example of a positional relationship between a three-dimensional tomographic image of interest and a reference tomographic image according to a second exemplary embodiment of the present invention.

FIG. 12 is a flow chart illustrating an example of processing for correcting positional deviation of a tomographic image of interest, which is executed in step S650 illustrated in FIG. 6, according to the second exemplary embodiment of the present invention.

FIG. 13 illustrates an example of a result of the processing in step S650 illustrated in FIG. 6 according to the second exemplary embodiment of the present invention.

FIGS. 14A and 14B illustrate an example of a blood vessel image (characteristic) in a tomographic image according to a third exemplary embodiment of the present invention.

FIG. 15 illustrates an exemplary functional configuration of an imaging apparatus according to the third exemplary embodiment of the present invention.

FIG. 16 is a flow chart illustrating an example of processing for setting a reference tomographic image capturing parameter, which is executed in step S630 illustrated in FIG. 6, according to the third exemplary embodiment of the present invention.

FIGS. 17A and 17B illustrate an example of a tomographic image of interest and an integrated image according to the third exemplary embodiment of the present invention.

FIG. 18 is a flow chart illustrating an example of processing for correcting positional deviation of a tomographic image of interest, which is executed in step S650 illustrated in FIG. 6, according to a fourth exemplary embodiment of the present invention.

FIG. 19 illustrates an example of a result of the processing in step S650 illustrated in FIG. 6 according to the fourth exemplary embodiment of the present invention.

FIG. 20 illustrates an example of a leukopathy (white spot) image (characteristic) in a tomographic image according to a fifth exemplary embodiment of the present invention.

FIG. 21 illustrates an exemplary functional configuration of an imaging apparatus according to the fifth exemplary embodiment of the present invention.

FIG. 22 is a flow chart illustrating an example of processing executed in a control method for controlling the imaging apparatus according to the fifth exemplary embodiment of the present invention.

FIG. 23 is a flow chart illustrating an example of processing for setting a reference tomographic image capturing parameter, which is executed in step S2220 illustrated in FIG. 22, according to the fifth exemplary embodiment of the present invention.

FIG. 24A illustrates an example of a tomographic image capturing position observed from a point of view of a tomographic image acquisition apparatus and FIG. 24B illustrates an example of a tomographic image capturing position on a retina of a subject's eye.

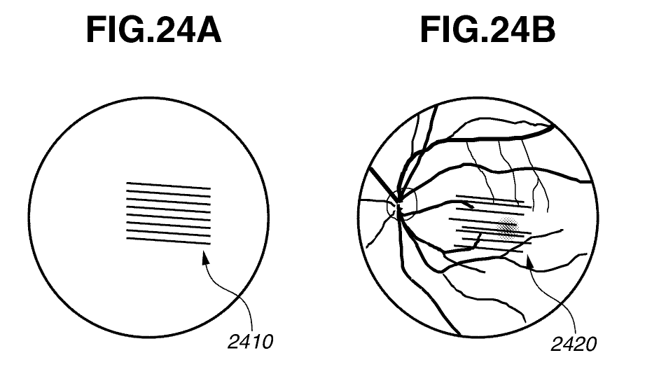

### DESCRIPTION OF THE EMBODIMENTS

Various exemplary embodiments, features, and aspects of the invention will be described in detail below with reference to the drawings.

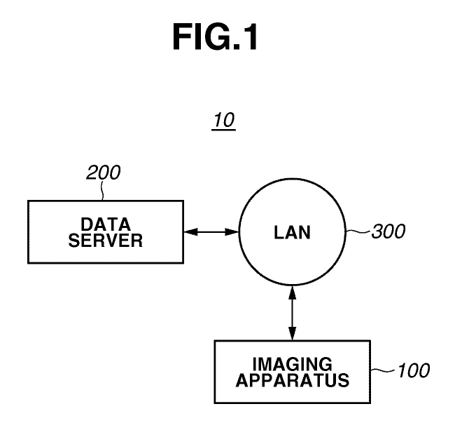

FIG. 1 illustrates an exemplary configuration of an imaging system including an imaging apparatus according to a first exemplary embodiment of the present invention.

Referring to FIG. 1, an imaging system 10 includes an imaging apparatus 100, a data server 200, and a local area network (LAN) 300.

More specifically, in the imaging system 10, the imaging apparatus 100 is connected to the data server 200 via the LAN 300, such as Ethernet (IEEE 802.3 standard).

In the example illustrated in FIG. 1, the connection between the imaging apparatus 100 and the data server 200 is implemented via the LAN 300. However, the present exemplary embodiment is not limited to this.

More specifically, it is also useful if an interface, such as universal serial bus (USB) or Institute of Electrical and Electronic Engineers (IEEE)1394 (FireWire) interface, is used to mutually connect the imaging apparatus 100 and the data server 200 instead of the LAN 300. In addition, it is also useful if an external network (wired or wireless), such as the Internet, is used in place of or in addition to LAN 300.

In the present exemplary embodiment, the imaging apparatus 100 captures a tomographic image of the eye of a subject person (i.e., a subject's eye) as an examination subject.

In the present exemplary embodiment, a subject's eye is used as an example of a subject. However, the present invention is not limited to this. More specifically, it is also useful if an image that can be captured as a tomographic image is used as a subject.

More specifically, the imaging apparatus 100 according to the present exemplary embodiment executes image analysis on a captured tomographic image of interest (a three-dimensional tomographic image of interest). In addition, the imaging apparatus 100 sets an optimal image capturing parameter for a reference tomographic image, which is to be used in correcting positional deviation of the tomographic image of interest based on a result of the analysis.

Furthermore, the imaging apparatus 100 captures a reference tomographic image by using the set image capturing parameter and corrects positional deviation of the tomographic image of interest by using the captured reference tomographic image.

In the present exemplary embodiment, an image capturing parameter refers to a parameter used in executing a scanning method. More specifically, an image capturing parameter includes a parameter for various setting items, such as a portion that is a target of acquiring a reference tomographic image, a position of the acquired reference tomographic image, a spatial range of a tomographic image, a degree of narrowing an interval between scan lines, an order of scanning, a direction of scanning, or a speed of scanning.

The data server 200 is a server that stores a tomographic image of a subject's eye output from the imaging apparatus 100, information including a result of analysis on the tomographic image, and information about an image capturing parameter used in capturing a tomographic image. In addition, the data server 200 transmits, to the imaging apparatus 100, history data of a subject's eye according to a request from the imaging apparatus 100.

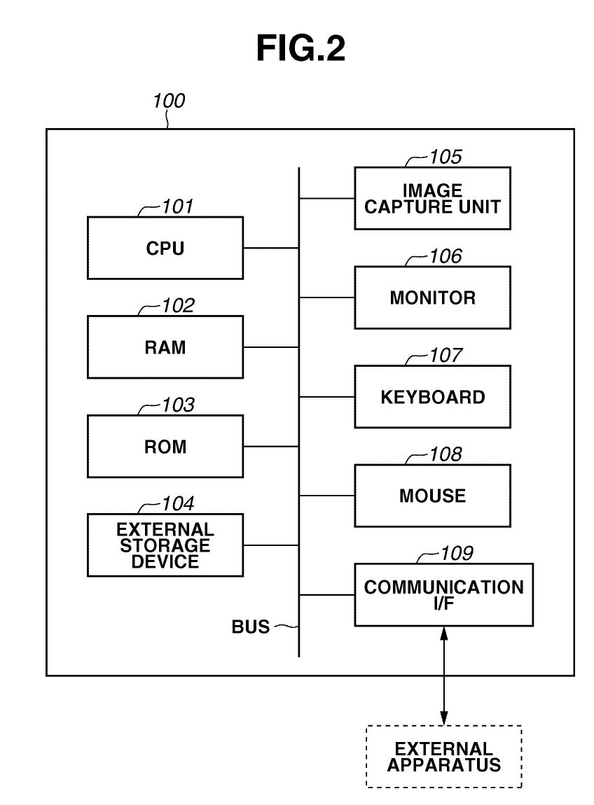

Now, an exemplary hardware configuration of the imaging apparatus 100 illustrated in FIG. 1 will be described in detail below with reference to FIG. 2. Referring to FIG. 2, the imaging apparatus 100 includes various components, such as a central processing unit (CPU) 101, a random access memory (RAM) 102, a read-only memory (ROM) 103, an external storage device 104, an imaging unit 105, a monitor 106, a keyboard 107, a mouse 108, a communication I/F 109, and a bus.

The CPU 101 controls an operation of the entire imaging apparatus 100 by using a program and data stored on the ROM 103 or the external storage device 104. The RAM 102 includes a temporary storage area for temporarily storing a program and data loaded from the external storage device 104 or the ROM 103. In addition, the RAM 102 includes a work area necessarily used by the CPU 101 in executing various processing.

The ROM 103 generally stores a basic input output system (BIOS) of a computer and setting data. The external storage device 104 functions as a mass storage device, such as a hard disk drive (HDD). More specifically, the external storage device 104 stores an operating system (OS) or a program executed by the CPU 101.

In the present exemplary embodiment, various information and data that are assumed to be already stored is stored in the external storage device 104 and is loaded onto the RAM 102 where necessary. Furthermore, in the present exemplary embodiment, it is supposed that the program executed by the CPU 101 is stored on the external storage device 104. However, the present exemplary embodiment is not limited to this. More specifically, it is also useful if the program executed by the CPU 101 is stored on the ROM 103.

The imaging unit 105 captures various images of a subject, such as a tomographic image of the subject (i.e., a subject's eye in the present exemplary embodiment). The monitor 106 includes a liquid crystal display (LCD). The keyboard 107 and the mouse 108 are examples of an input device according to the present exemplary embodiment. An operator can input various instructions to the imaging apparatus 100 by using the input device.

The communication interface (I/F) 109 is an interface for various data communications executed between the imaging apparatus 100 and an external apparatus (shown without reference number in FIG. 2), such as the data server 200 (shown in FIG. 1). More specifically, the communication I/F 109 includes, for example, an IEEE 1394, a USB, or an Ethernet port. Data acquired via the communication I/F 109 is input to the external storage device 104 and then is loaded onto the RAM 102 where necessary.

The BUS illustrated in FIG. 2 mutually connects the CPU 101, the RAM 102, the ROM 103, the external storage device 104, the imaging unit 105, the monitor 106, the keyboard 107, the mouse 108, and the communication I/F 109 of the imaging apparatus 100. Accordingly, the above-described components of the imaging apparatus 100 can execute data communication among them and with external apparatuses.

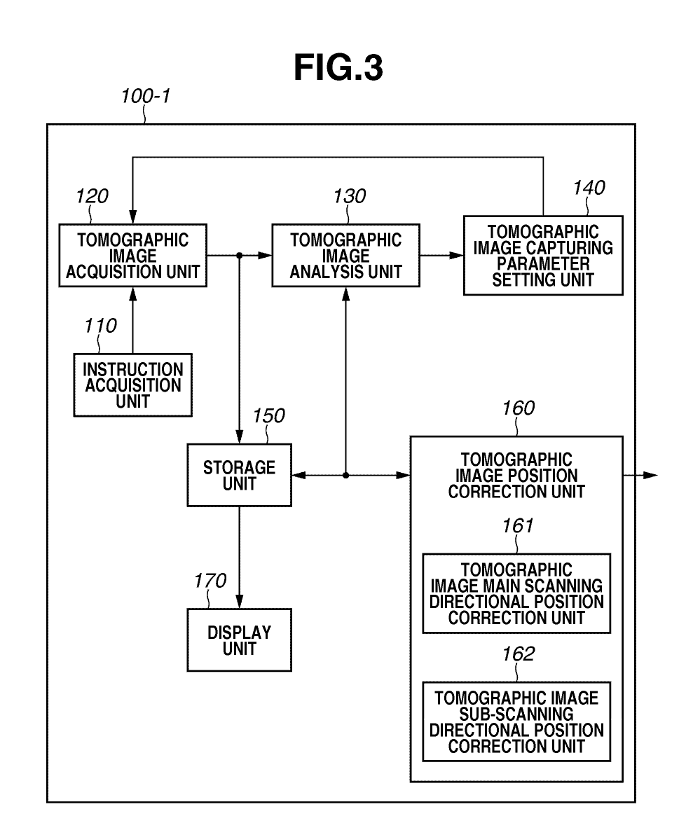

Now, an exemplary functional configuration of the imaging apparatus 100 according to the first exemplary embodiment will be described in detail below with reference to FIG. 3. FIG. 3 illustrates an exemplary functional configuration of the imaging apparatus 100 according to the first exemplary embodiment of the present invention. In the following description, the imaging apparatus 100 according to the first exemplary embodiment illustrated in FIG. 3 will be described as an “imaging apparatus 100-1”.

Referring to FIG. 3, the imaging apparatus 100-1 includes various components, such as an instruction acquisition unit 110, a tomographic image acquisition unit 120, a tomographic image analysis unit 130, a tomographic image capturing parameter setting unit 140, a storage unit 150, a tomographic image position correction unit 160, and a display unit 170. Furthermore, the tomographic image position correction unit 160 includes a tomographic image main scanning direction position correction unit 161 and a tomographic image sub-scanning direction position correction unit 162.

In the present exemplary embodiment, the instruction acquisition unit 110 illustrated in FIG. 3 includes the CPU 101 (FIG. 2), a program stored on the external storage device 104 (FIG. 2), and the input device, such as the keyboard 107 and the mouse 108 (FIG. 2). Furthermore, in the present exemplary embodiment, the tomographic image acquisition unit 120 illustrated in FIG. 3 includes the CPU 101 (FIG. 2), a program stored on the external storage device 104 (FIG. 2), and the imaging unit 105.

Furthermore, each of the tomographic image analysis unit 130 and the tomographic image capturing parameter setting unit 140 include the CPU 101 (FIG. 2) and a program stored on the external storage device 104 (FIG. 2). The storage unit 150 illustrated in FIG. 3 includes the RAM 102 (FIG. 2), the ROM 103 (FIG. 2), or the external storage device 104 (FIG. 2).

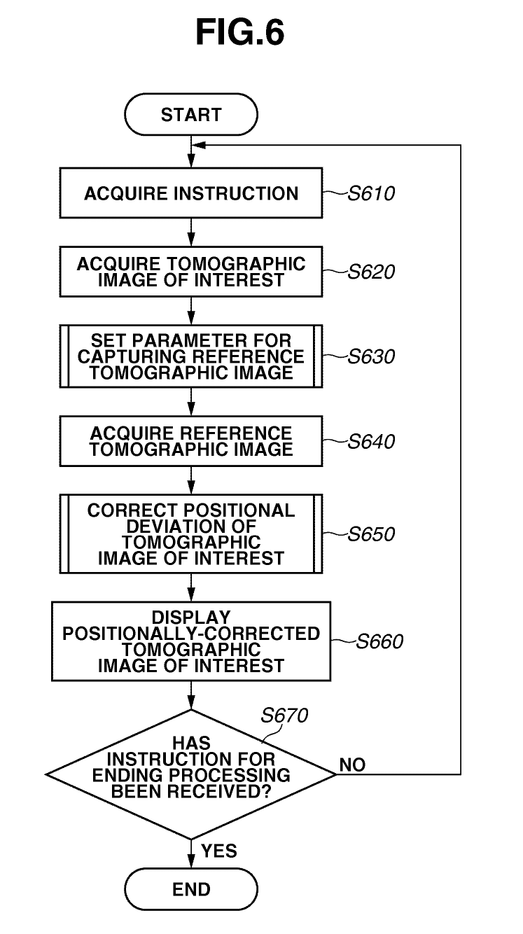

The tomographic image position correction unit 160 illustrated in FIG. 3 includes the CPU 101 (FIG. 2), a program stored on the external storage device 104 (FIG. 2), the external storage device 104, and the communication I/F 109 (FIG. 2). The display unit 170 illustrated in FIG. 3 includes the CPU 101 (FIG. 2), a program stored on the external storage device 104 (FIG. 2), and the monitor 106 (FIG. 2). A function of each component of the imaging apparatus 100-1 illustrated in FIG. 3 will also be described in detail below with reference to a flow chart of each of FIGS. 6, 7, and 9.

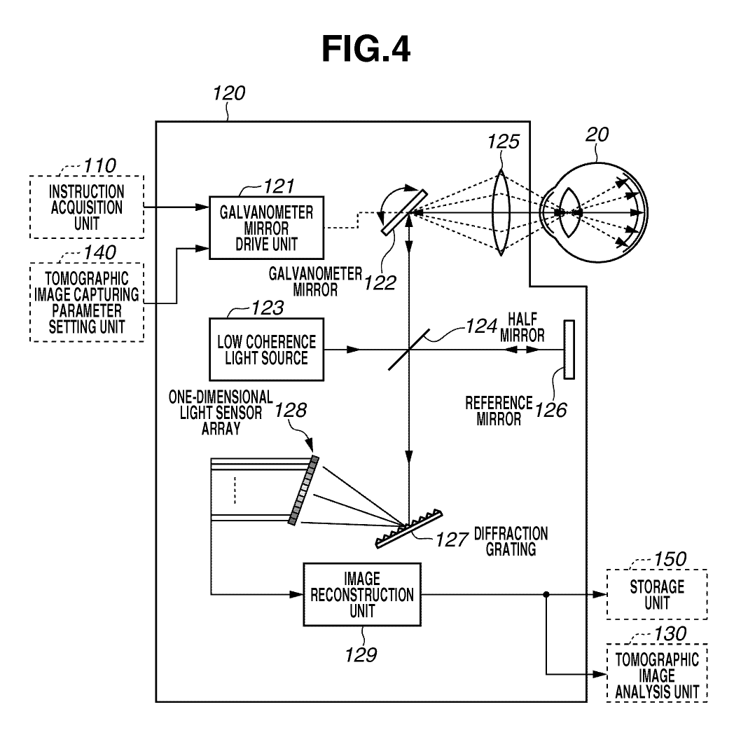

Now, an exemplary inner configuration of the tomographic image acquisition unit 120 illustrated in FIG. 3 will be described in detail below with reference to FIG. 4. FIG. 4 illustrates an exemplary inner configuration of the tomographic image acquisition unit 120 illustrated in FIG. 3. In the present exemplary embodiment, the tomographic image acquisition unit 120 includes a Fourier domain type OCT.

Referring to FIG. 4, the tomographic image acquisition unit 120 includes a galvanometer mirror drive unit 121, a galvanometer mirror 122, a low coherence light source 123, a half mirror 124, an objective lens 125, a reference mirror 126, a diffraction grating 127, a one-dimensional light sensor array 128, and an image reconstruction unit 129.

The tomographic image acquisition unit 120 controls the galvanometer mirror drive unit 121 to drive the galvanometer mirror 122 according to information included in an operator instruction for capturing an image acquired by the instruction acquisition unit 110 and an image capturing parameter set by the tomographic image capturing parameter setting unit 140.

In addition, the tomographic image acquisition unit 120 divides a beam of light from the low coherence light source 123 into a signal light beam that goes in a direction of a subject's eye 20 via the objective lens 125 and a reference light beam that goes in a direction of the reference mirror 126 by using the half mirror 124 and.

In addition, the tomographic image acquisition unit 120 superposes the signal light beam and the reference light beam, which have now reflected from the subject's eye 20 and the reference mirror 126, respectively, to generate coherent light. Furthermore, the tomographic image acquisition unit 120 splits the generated coherent light into wavelength components of wavelengths of λ1 to λn by using the diffraction grating 127. Moreover, the tomographic image acquisition unit 120 detects each of the wavelength components by using the one-dimensional light sensor array 128.

Each of one-dimensional light sensors included in the one-dimensional light sensor array 128 outputs a detected signal of intensity of light of the detected wavelength component to the image reconstruction unit 129. Based on the detected signal of each wavelength component of the coherent light output from the one-dimensional light sensor array 128, the image reconstruction unit 129 calculates a relationship between the wavelength and the intensity of light about the coherent light. More specifically, the image reconstruction unit 129 calculates a distribution of intensity of light of the coherent light (wavelength spectrum).

In addition, the image reconstruction unit 129 executes Fourier transform on the calculated wavelength spectrum of the coherent light. Furthermore, the image reconstruction unit 129 reconstructs the tomographic image of the retina of the subject's eye 20. Moreover, the image reconstruction unit 129 outputs the reconstructed tomographic image of the retina of the subject's eye 20 to the storage unit 150 and the tomographic image analysis unit 130.

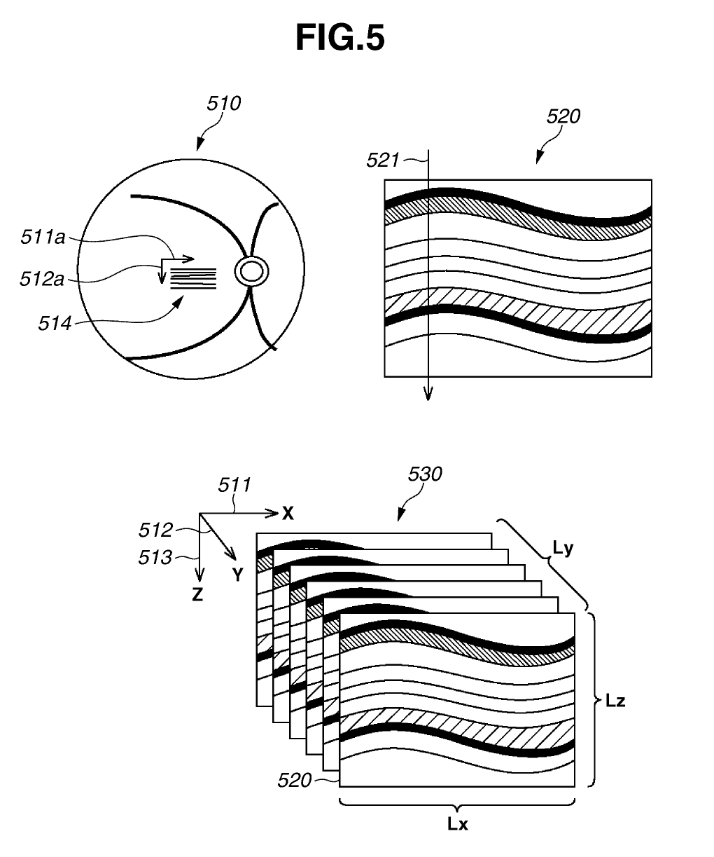

Now, a tomographic image that is reconstructed by the image reconstruction unit 129 of the tomographic image acquisition unit 120 will be described in detail below with reference to FIG. 5. FIG. 5 illustrates an example of a tomographic image acquired by the image reconstruction unit 129 of the tomographic image acquisition unit 120 illustrated in FIG. 4.

Referring to FIG. 5, an image 510 indicates an image of the retina of the subject's eye 20. An image 520 indicates a tomographic image of the retina of the subject's eye 20, which is acquired by the tomographic image acquisition unit 120. More specifically, the image 520 corresponds to an image on a two-dimensional cross section of the retina in the direction of depth and in a direction perpendicular to the retinal depth direction. To paraphrase this, the image 520 corresponds to an image on a plane on an X-axis 511 and a Z-axis 513.

The image 520 includes scan lines used in scanning the retina of the subject's eye 20 in its depth direction for a plurality of times. In the following description, the scan lines are referred to as “A-scans 521”. Furthermore, the image 520, which constructs a two-dimensional tomographic image of the retina of the subject's eye 20 in its depth direction, is referred to as a “B-scan image (B-scan tomographic image)”.

A position 514 indicates a position of the image 520. Scan lines scan the retina to construct one B-scan image. The above-described scanning is referred to as “main scanning” (or “transversal scanning”).

In the example illustrated in FIG. 5, X-axes 511 and 511a indicate the main scanning direction. In addition, Y-axes 512 and 512a indicate a direction of imaging and scanning when tomographic images are serially captured. The imaging and scanning is collectively referred to as “sub-scanning”. Moreover, the Z-axis 513 indicates a direction of depth of the A-scan.

As described above, in the present exemplary embodiment, the main scanning direction is indicated on the X-axis 511. The sub-scanning direction is indicated on the Y-axis 512. The direction of depth is indicated on the Z-axis 513.

By executing an image capturing operation while displacing the image capturing position of a B-scan image in the sub-scanning direction (i.e., in the direction of the Y-axis 512), a three-dimensional tomographic image 530 is captured. In order to reconstruct the tomographic images illustrated in FIG. 5, the tomographic image acquisition unit 120 reconstructs the A-scan 521 line by line while moving the galvanometer mirror 122 in the main scanning direction to construct one B-scan image.

A tomographic image (three-dimensional tomographic image) 530 acquired in the above-described manner is then output from the tomographic image acquisition unit 120 to the storage unit 150 as a tomographic image of interest. The storage unit 150 temporarily stores the tomographic image of interest. In the present exemplary embodiment, a relative position of B-scan images other than one B-scan image, which is designated from within the three-dimensional tomographic image 530 as a reference tomographic image, is indicated with coordinates (x, y, z).

In capturing the three-dimensional tomographic image 530, if the eyeball of the subject user (the subject's eye 20) moves, either voluntarily or involuntarily, the image capturing position for capturing a B-scan image may be displaced from the desired image capturing position. Accordingly, in this case, it becomes necessary to correct the relative position (x, y, z) among the actually captured B-scan images.

Now, processing in the method executed by the imaging apparatus 100 (FIG. 1) according to the present exemplary embodiment will be described in detail below. FIG. 6 is a flow chart illustrating an example of processing in the method executed by the imaging apparatus 100 (FIG. 1) according to the present exemplary embodiment.

Referring to FIG. 1, in step S610, the instruction acquisition unit 110 acquires information about an instruction for capturing a tomographic image of interest, which is an image of interest of the fundus a subject (subject's eye).

More specifically, in step S610, the instruction acquisition unit 110 acquires an instruction, such as an image capturing parameter including information about a portion of the fundus and a position thereof and an image capturing range of the fundus of the subject's eye that is the target of capturing a tomographic image, as the information about an instruction for capturing a tomographic image of interest (hereinafter may also be simply referred to as a “(tomographic) image capturing instruction”).

The tomographic image of interest capturing instruction is input by an operator by operating the keyboard 107 and the mouse 108 of the instruction acquisition unit 110. Furthermore, the instruction acquisition unit 110 transmits the acquired information about the image capturing instruction to the tomographic image acquisition unit 120.

In step S620, the tomographic image acquisition unit 120 executes processing for capturing a tomographic image of interest (three-dimensional tomographic image of interest) by capturing a three-dimensional tomographic image of the retina of the subject's eye according to the tomographic image capturing instruction (image capturing parameter) acquired by the instruction acquisition unit 110.

In the present exemplary embodiment, the tomographic image of interest (three-dimensional tomographic image of interest) acquired in step S620 implements a first tomographic image. Furthermore, in the present exemplary embodiment, the tomographic image acquisition unit 120, which executes the processing in step S620, implements a first tomographic image acquisition unit.

In addition, in step S620, the tomographic image acquisition unit 120 outputs the acquired tomographic image of interest to the storage unit 150 and the tomographic image analysis unit 130.

In step S630, at first, the tomographic image position correction unit 160 and the tomographic image analysis unit 130 execute predetermined processing. Then, the tomographic image capturing parameter setting unit 140 executes processing for setting a reference tomographic image capturing parameter. In the present exemplary embodiment, a reference tomographic image capturing parameter is set for capturing a reference tomographic image optimum for correcting positional deviation of the tomographic image of interest acquired in step S620.

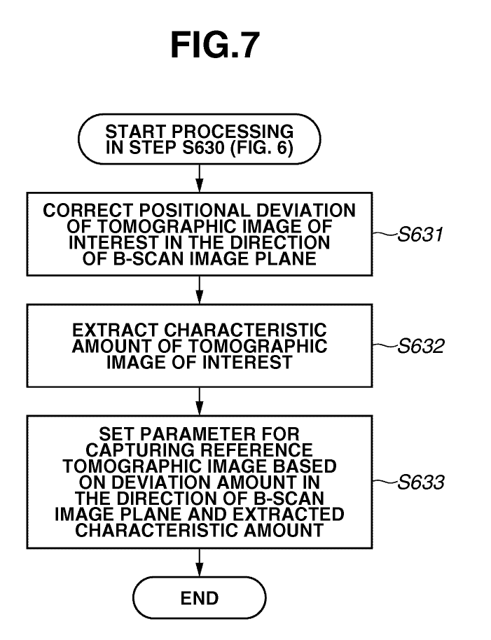

In step S630, processing briefly described below is executed. The following processing will be described in detail below with reference to FIG. 7.

In step S630, the tomographic image main scanning direction position correction unit 161 of the tomographic image position correction unit 160 executes processing for correcting positional deviation among the B-scan images of the tomographic image of interest (three-dimensional tomographic image of interest) captured and acquired by the tomographic image acquisition unit 120 in the directions of X-axis and Z-axis.

Furthermore, the tomographic image analysis unit 130 extracts a characteristic amount, which is a reference of correcting positional deviation among the B-scan images of the tomographic image of interest (three-dimensional tomographic image of interest) whose positional deviation in the directions of X-axis and Z-axis has been corrected by the tomographic image position correction unit 160 by using the tomographic image main scanning direction position correction unit 161.

In addition, the tomographic image capturing parameter setting unit 140 sets an image capturing parameter, which is used in capturing a reference tomographic image including a large number of characteristic amounts extracted by the tomographic image analysis unit 130, as a reference tomographic image capturing parameter. Furthermore, the tomographic image capturing parameter setting unit 140 transmits the reference tomographic image capturing parameter to the tomographic image acquisition unit 120.

In step S640, the tomographic image acquisition unit 120 executes processing for capturing and acquiring a reference tomographic image according to the reference tomographic image capturing parameter set in step S630. In the present exemplary embodiment, the reference tomographic image acquired in step S640 implements a second tomographic image. Furthermore, in the present exemplary embodiment, the tomographic image acquisition unit 120, which executes the processing in step S640, implements a second tomographic image acquisition unit. In addition, the tomographic image acquisition unit 120 outputs the reference tomographic image acquired in step S640 to the storage unit 150.

In step S650, the tomographic image position correction unit 160 corrects positional deviation of a tomographic image of interest by using the reference tomographic image acquired in step S640. More specifically, in step S650, the tomographic image position correction unit 160 identifies a positional relationship between the reference tomographic image and the tomographic image of interest (the three-dimensional tomographic image of interest) and corrects positional deviation of the tomographic image of interest in the direction of the Y-axis based on the identified positional relationship.

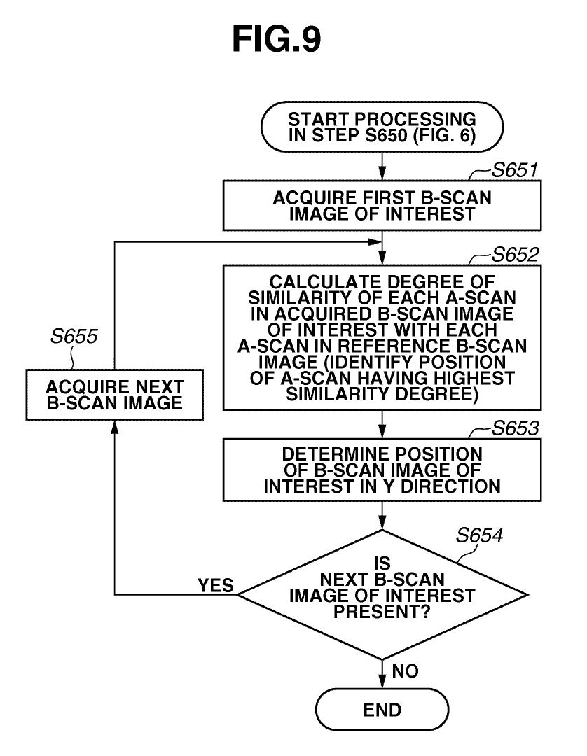

After correcting the positional deviation of the tomographic image of interest (the three-dimensional tomographic image of interest) in the directions of X-, Y-, and Z-axes, the tomographic image position correction unit 160 transmits the positionally corrected tomographic image of interest (the three-dimensional tomographic image of interest) to the storage unit 150 or an external apparatus. The processing in step S650 according to the present exemplary embodiment will be described in detail below with reference to FIG. 9.

In step S660, the display unit 170 inputs the tomographic image of interest (three-dimensional tomographic image of interest), whose positional deviation has been corrected in step S650, from the storage unit 150. In addition, the display unit 170 displays the input tomographic image of interest (three-dimensional tomographic image of interest) on the monitor 106.

More specifically, in three-dimensionally displaying the tomographic image of interest (three-dimensional tomographic image of interest), the display unit 170 arranges each B-scan image of interest in a three-dimensional display space based on information about each positionally corrected B-scan image of interest (i.e., based on the coordinates (x, y, z) of each positionally corrected B-scan image of interest). It is also useful if the display unit 170 executes interpolation on the B-scan images of interest and displays the interpolated B-scan images after arranging each B-scan image of interest in the three-dimensional display space.

In step S670, the instruction acquisition unit 110 determines whether to end the processing on the tomographic image of interest based on the information about the instruction on whether to end the processing on the tomographic image of interest, which is externally acquired. The instruction is input by the operator via the keyboard 107 and the mouse 108 of the instruction acquisition unit 110, similar to the processing in step S610.

If it is determined that the processing on the tomographic image of interest is not to be ended (that the processing on the tomographic image of interest is to be continued) (NO in step S670), then the processing returns to step S610 and starts processing on a next subject's eye (or executes processing on the same subject's eye again). On the other hand, if it is determined that the processing on the tomographic image of interest is to be ended (YES in step S610), then the processing illustrated in FIG. 6 ends.

Now, the processing in step S630 illustrated in FIG. 6 will be described in detail below with reference to FIG. 7. FIG. 7 is a flow chart illustrating an example of the processing for setting a reference tomographic image capturing parameter, which is executed in step S630 illustrated in FIG. 6, according to the present exemplary embodiment.

Referring to FIG. 7, in step S631, the tomographic image main scanning direction position correction unit 161 corrects positional deviation of the B-scan images of the tomographic image of interest (three-dimensional tomographic image of interest), which have been captured and acquired by the tomographic image acquisition unit 120, in the directions of X-axis and Z-axis.

Furthermore, the tomographic image main scanning direction position correction unit 161 outputs the tomographic image of interest (three-dimensional tomographic image of interest) that have been positionally corrected in the main scanning direction to the tomographic image analysis unit 130 and the storage unit 150.

Now, the processing for correcting the positional deviation of a three-dimensional tomographic image of interest in the main scanning direction, which is executed in step S631 illustrated in FIG. 7, will be described in detail below.

More specifically, in the present exemplary embodiment, the “correction of positional deviation of a tomographic image in the main scanning direction” refers to “correction of positional deviation of a tomographic image in the direction of a plane including the B-scan image” or “correction of positional deviation of a tomographic image in the directions of the X-axis and the Z-axis”.

In the present exemplary embodiment, it is supposed that a B-scan image is processed as a three-dimensional tomographic image of interest to be processed. The present exemplary embodiment executes the following two-dimensional image processing on each B-scan image.

More specifically, the tomographic image main scanning direction position correction unit 161 determines a region of interest (hereinafter simply referred to as an “ROI”), which is used in calculating the amount of positional deviation among adjacent B-scan images. In addition, the tomographic image main scanning direction position correction unit 161 executes processing for searching for mutually adjacent B-scan images having the same pattern by using a pattern matching method.

In the present exemplary embodiment, a sum of squares difference (SSD) expressed by the following expression (1) is used as the degree of similarity in the pattern matching method:

$$SSD = \frac{1}{N} {\sum }_{i} {\sum }_{j} {( A ( i , j ) - B ( i , j ) )}^{2} \qquad ( 1 )$$

where “A” and “B” denote pixel values of the ROI of the mutually adjacent B-scan images, “i” and “j” denote a position of a pixel within the ROI, and “N” denotes the total number of pixels existing within the ROI.

Furthermore, the tomographic image main scanning direction position correction unit 161 searches for a position at which the SSD becomes minimum while translating the ROI from the adjacent tomographic image within a plane of the tomographic image. More specifically, the translation of the ROI is executed by moving the pixel having a coordinate x (in a direction of width of the image) and a coordinate z (in a direction of height of the image) against the adjacent tomographic image within the plane of the tomographic image.

In addition, the tomographic image main scanning direction position correction unit 161 sets the amount of positional deviation of the adjacent B-scan image according to the position at which the SSD becomes minimum. In the present exemplary embodiment, it is supposed that the size of the ROI has been previously determined based on the range of capturing an image and the dimension of the subject. More specifically, it is also useful if the ROI has the size of 128×128 pixels. However, the present exemplary embodiment is not limited to this. More specifically, it is also useful if a range of two-thirds of the entire B-scan image is used as the size of the ROI.

In the present exemplary embodiment, the tomographic image main scanning direction position correction unit 161 calculates the amount of positional deviation of a B-scan image based on the SSD. However, the present exemplary embodiment is not limited to this. More specifically, it is also useful if the tomographic image main scanning direction position correction unit 161 calculates the amount of positional deviation of a B-scan image by using a publicly known method, such as a mutual information amount method or a cross-correlation coefficient method.

In addition, the tomographic image main scanning direction position correction unit 161 corrects the positional deviation among the B-scan images in the directions of the X-axis and the Z-axis according to the calculated positional deviation amount and acquires a positionally corrected tomographic image of interest (three-dimensional tomographic image of interest).

Furthermore, the tomographic image main scanning direction position correction unit 161 transmits the positionally corrected tomographic image of interest (the three-dimensional tomographic image of interest) and information about the coordinates (x, z) of each B-scan image to the storage unit 150. In the following description, the tomographic image of interest (three-dimensional tomographic image of interest) that has been positionally corrected in the directions of the X-axis and the Z-axis is referred to as an “XZ-corrected three-dimensional tomographic image of interest”.

In step S632 (FIG. 7), the tomographic image analysis unit 130 reads the XZ-corrected three-dimensional tomographic image of interest from the storage unit 150 and executes processing for extracting the characteristic amount of the XZ-corrected three-dimensional tomographic image of interest. In the present exemplary embodiment, the tomographic image analysis unit 130 extracts an amount of variation of contrast as the characteristic amount.

More specifically, the tomographic image analysis unit 130 extracts an amount of variation of contrast (“contrast variation amount” g (i, j, k) with respect to each B-scan image of the XZ-corrected three-dimensional tomographic image of interest by using the following expression (2):

$$g ( i , j , k ) = \sqrt{{\{ \begin{matrix}f ( i + 1 , j , k ) - \\ f ( i , j , k )\end{matrix} \}}^{2} + {\{ \begin{matrix}f ( i , j + 1 , k ) - \\ f ( i , j , k )\end{matrix} \}}^{2}} \\ where \\ i = 0 , 1 , … , {L}_{x} - 1 \\ j = 0 , 1 , … , {L}_{z} - 1 \\ k = 0 , 1 , … , {L}_{y} - 1 \qquad ( 2 )$$

In expression (2), “(i, j, k)” denote a pixel value of the three-dimensional tomographic image of interest at a position (i, j, k), “Lx” denotes the number of pixels existing in the direction of the X-axis 511 if the three-dimensional tomographic images 530 (FIG. 5) is set as a three-dimensional tomographic image of interest, “Lz” denotes the number of pixels existing in the direction of the Z-axis 513 in this case, and “Ly” denotes the number of pixels existing in the direction of the Y-axis 512 in this case.

Furthermore, the tomographic image analysis unit 130 transmits the characteristic amount extracted from the XZ-corrected three-dimensional tomographic image of interest to the tomographic image capturing parameter setting unit 140.

In the present exemplary embodiment, the contrast variation amount is extracted as the characteristic amount. However, the present exemplary embodiment is not limited to this. More specifically, it is also useful if any characteristic amount is extracted that spatially differs from the characteristic amount of the surroundings within an image and with which the position of the image can be identified.

More specifically, if the edge intensity of an image is used as the characteristic amount, it is also useful if a Laplacian filter, a Sobel filter, or a Canny filter is used. Furthermore, as described above, the present exemplary embodiment executes two-dimensional image processing in extracting the characteristic amount. However, the present exemplary embodiment is not limited to this. More specifically, it is also useful if the present exemplary embodiment executes three-dimensional image processing to extract the characteristic amount.

In step S633, the tomographic image capturing parameter setting unit 140 sets an image capturing parameter for capturing a reference tomographic image based on the characteristic amount extracted in step S632. More specifically, in the present exemplary embodiment, the tomographic image capturing parameter setting unit 140 uses the contrast variation amount g (i, j, k), which has been extracted in step S632, to set a parameter for capturing a reference tomographic image that intersects a region in which the contrast variation amount is as large as possible based on the contrast variation amount g.

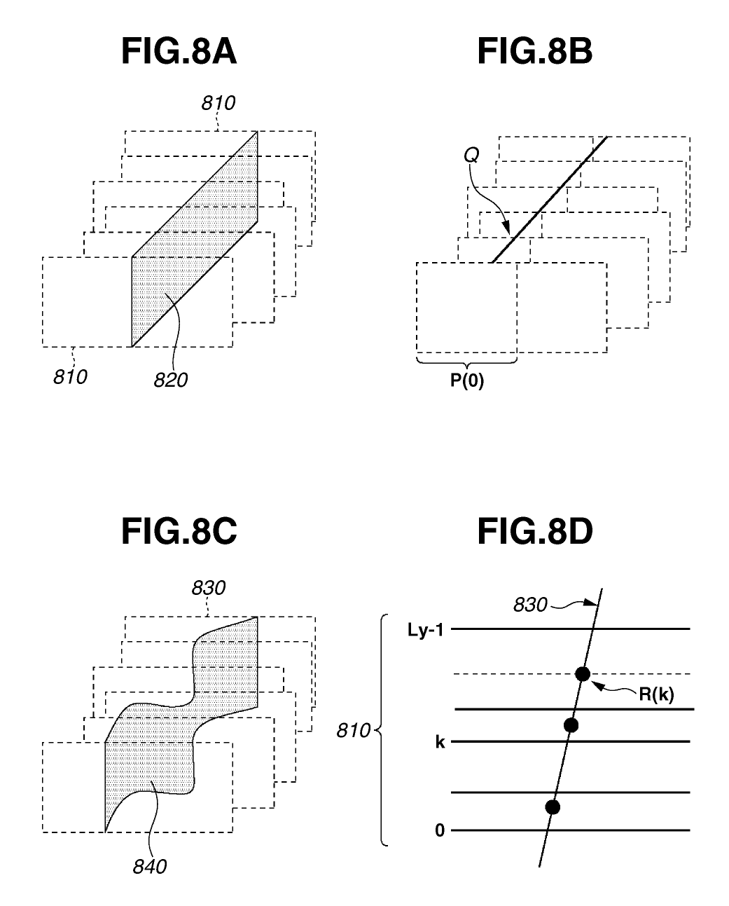

FIGS. 8A through 8D illustrate an example of the positional relationship between a three-dimensional tomographic image of interest 810 and a reference tomographic image 820 calculated based on the extracted characteristic amount of the three-dimensional tomographic image of interest according to the present exemplary embodiment.

The tomographic image capturing parameter setting unit 140 sets a parameter for capturing the reference tomographic image 820 so that the reference tomographic image 820 illustrated in FIG. 8A intersects a portion of the three-dimensional tomographic image of interest 810 illustrated in FIG. 8A having as large a characteristic amount as possible.

Now, an example of the image capturing parameter according to the present exemplary embodiment will be described in detail below.

The tomographic image capturing parameter setting unit 140 calculates a position P(k) of a k-th B-scan image of the three-dimensional tomographic image of interest 810, at which a value calculated by integrating the contrast variation amount g, which is calculated in step S632, becomes maximum by using the following expression (3):

$$P ( k ) = {arg max}_{i} ( {\sum }_{j = 0}^{j \leq {L}_{z} - 1} g ( i , j , k ) ) \qquad ( 3 )$$

where the position P(k) satisfies the condition “0≦P(k)≦Lx” and denotes the position, in the direction of the X-axis, of the k-th B-scan image of the three-dimensional tomographic image of interest 810 at which an integrated value of the contrast variation amount g (i, j, k) becomes maximum.

In addition, the tomographic image capturing parameter setting unit 140 calculates a locus Q, along which an error against each position P(k) becomes minimum as illustrated in FIG. 8B. More specifically, in calculating the locus Q, it is useful to use a publicly known method, such as a method of least square, by using the position P(k) as a dependent variable against a position k of the B-scan image.

Furthermore, the tomographic image capturing parameter setting unit 140 sets an image capturing parameter for the reference tomographic image 820, which is used as a reference tomographic image for calculating the plane intersecting the locus Q that is calculated in the above-described manner.

More specifically, the tomographic image capturing parameter setting unit 140 sets an image capturing parameter with which the scanning of the light beam executed by the galvanometer mirror drive unit 121 of the tomographic image acquisition unit 120 goes along the locus Q. In addition, the tomographic image capturing parameter setting unit 140 transmits the image capturing parameter set in the above-described manner to the tomographic image acquisition unit 120.

It is also useful if a candidate of a reference two-dimensional tomographic image is captured along a curved plane intersecting the three-dimensional tomographic images of interest 830, as illustrated in FIG. 8C, instead of capturing the same along a flat plane. In calculating the curved plane, it is useful to use a B spline curve.

However, because the galvanometer mirror 122 moves to execute a main scanning operation in capturing a B-scan image by using the tomographic image acquisition unit 120 as described above, it is necessary to capture a reference two-dimensional tomographic image candidate along a curve having a shape along which the galvanometer mirror 122 can control the movement of the main scanning operation.

The present exemplary embodiment executes the processing in step S633 as described above. After executing the processing in step S633, the processing in the flow chart of FIG. 7 (the processing in step S630 of FIG. 6) ends.

In the present exemplary embodiment, after correcting the positional deviation of the three-dimensional tomographic image of interest in the direction of the B-scan image, the tomographic image main scanning direction position correction unit 161 extracts the characteristic amount. However, the present exemplary embodiment is not limited to this. More specifically, it is also useful if the tomographic image main scanning direction position correction unit 161 sets the parameter for capturing a reference tomographic image without executing the positional deviation correction processing described above.

Now, the processing in step S650 illustrated in FIG. 6 will be described in detail below with reference to FIG. 9. FIG. 9 is a flow chart illustrating an example of processing for correcting positional deviation of a tomographic image of interest, which is executed in step S650 illustrated in FIG. 6, according to the present exemplary embodiment.

In step S650 (FIG. 6), the tomographic image sub-scanning direction position correction unit 162 executes processing for correcting the positional deviation of the XZ-corrected three-dimensional tomographic image of interest in the direction of the Y-axis.

Referring to FIG. 9, in step S651, the tomographic image sub-scanning direction position correction unit 162 reads the three-dimensional tomographic image of interest 810, which is illustrated in FIG. 8A, from the storage unit 150. In addition, the tomographic image sub-scanning direction position correction unit 162 acquires the first B-scan image of interest b(k) of the three-dimensional tomographic image of interest 810. In the processing in the following steps, the tomographic image sub-scanning direction position correction unit 162 executes processing for positionally aligning the acquired B-scan image of interest and the reference tomographic image.

In step S652, the tomographic image sub-scanning direction position correction unit 162 identifies a position R(k) of an A-scan of the reference tomographic image 820 having a highest similarity degree from among A-scans included in the B-scan image of interest to be processed.

The degree of similarity is determined according to a result of calculating an SSD, which is expressed by using the above-described expression (1), on the A-scans existing within the B-scan image of interest and on the A-scans within the reference tomographic image.

FIG. 8D illustrates an example of the position R(k), which is identified in the above-described manner. The identified position R(k) is a position of a reference tomographic image at which the degree of similarity to the k-th B-scan image in the three-dimensional tomographic image of interest 810 becomes highest. The position R(k) is stored on a memory (not illustrated) provided within the tomographic image sub-scanning direction position correction unit 162.

In step S653, the tomographic image sub-scanning direction position correction unit 162 determines a position of the B-scan image of interest currently processed (in the direction of the Y-axis) according to the position R(k) of the A-scan acquired in step S652. Furthermore, the tomographic image sub-scanning direction position correction unit 162 executes the correction processing according to the determined position.

More specifically, the tomographic image sub-scanning direction position correction unit 162 executes the correction processing supposing that the position of the k-th B-scan image according to the reference tomographic image lies at a position on the broken line illustrated in FIG. 8D.

In addition, the tomographic image sub-scanning direction position correction unit 162 sets the positional relationship as positional information (y) about the k-th B-scan image in the direction of the Y-axis. Furthermore, the tomographic image sub-scanning direction position correction unit 162 combines the positional information in the direction of the Y-axis with the positional information about the B-scan image of interest in the directions of the X-axis and the Z-axis, which has been acquired in step S631, as one piece of coordinate information (x, y, z). In addition, the tomographic image sub-scanning direction position correction unit 162 transmits the combined information to the storage unit 150 together with the B-scan image of interest.

In step S654, the tomographic image sub-scanning direction position correction unit 162 determines whether a B-scan image of interest of the three-dimensional tomographic image of interest to be subsequently processed (i.e., a B-scan image of interest that has not been subjected to processing for correcting the positional deviation in the direction of the Y-axis yet) exists.

If it is determined that a B-scan image of interest to be subsequently processed exists (YES in step S652), then the processing advances to step S655. In step S655, the tomographic image sub-scanning direction position correction unit 162 acquires the B-scan image of interest to be subsequently processed from the storage unit 150. Then, the processing returns to step S652. In step S652, the tomographic image sub-scanning direction position correction unit 162 sets the B-scan image of interest to be subsequently processed, which has been acquired in step S655, as a B-scan image of interest to be processed. Then, the tomographic image sub-scanning direction position correction unit 162 executes the processing in step S652 and beyond.

On the other hand, if it is determined that no B-scan image of interest to be subsequently processed exists (NO in step S654), then the processing in the flow chart of FIG. 9 ends.

By executing the processing illustrated in FIG. 9, the processing in step S650 in FIG. 6 according to the present exemplary embodiment is implemented.

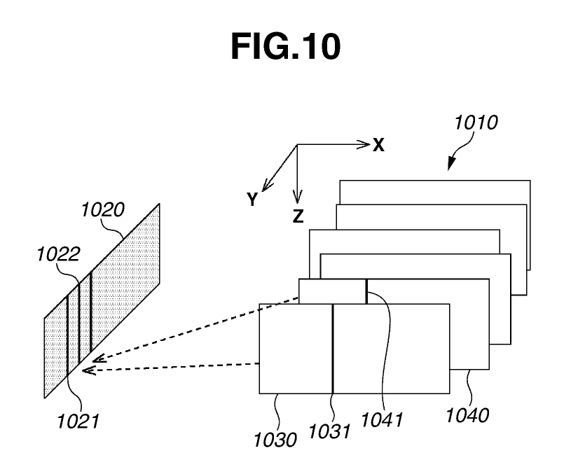

FIG. 10 illustrates an example of a result of the processing in step S650 illustrated in FIG. 6 according to the present exemplary embodiment.

Referring to FIG. 10, a three-dimensional tomographic image of interest 1010 is an XZ-corrected three-dimensional tomographic image of interest that has been subjected to the correction in step S631 (FIG. 7). A reference tomographic image 1020 is a reference tomographic image captured in step S640 (FIG. 6). Each of B-scan images 1030 and 1040 is a B-scan image of the three-dimensional tomographic image of interest 1010.

By executing the processing in step S650 described above, the position of each B-scan image included in the corrected three-dimensional tomographic image of interest 1010 against the reference tomographic image 1020 is determined

In the example illustrated in FIG. 10, in a specific B-scan image 1030 of the three-dimensional tomographic image of interest 1010, an A-scan 1031 has a highest degree of similarity with an A-scan 1021 of the reference tomographic image 1020. On the other hand, in another B-scan image 1040 of the three-dimensional tomographic image of interest 1010, an A-scan 1041 has a highest degree of similarity with an A-scan 1022 of the reference tomographic image 1020.

Accordingly, the position of the B-scan image 1030 in the direction of the Y-axis corresponds to the position of the A-scan 1021 of the reference tomographic image 1020. The present exemplary embodiment executes the correction processing in the direction of the Y-axis. In addition, the position of the B-scan image 1040 in the direction of the Y-axis corresponds to the position of the A-scan 1022 of the reference tomographic image 1020. Accordingly, the present exemplary embodiment executes the correction processing in the direction of the Y-axis.

In the present exemplary embodiment, the tomographic image sub-scanning direction position correction unit 162 stores the position after correction (x, y, z) together with each B-scan image of interest. However, the present exemplary embodiment is not limited to this. More specifically, it is also useful if the following configuration is employed. In other words, the present exemplary embodiment can correct the position of a pixel positioned at a position (x, z) by moving pixels existing within the plane of the B-scan image of interest (the X- and Z-axes plane) and store the position (y) of the B-scan image in the direction of the Y-axis only together with the B-scan image itself.

As described above, the present exemplary embodiment captures a reference tomographic image including a characteristic amount useful in aligning the position of the tomographic image according to a result of analyzing the tomographic image of interest. Furthermore, the present exemplary embodiment corrects the positional deviation of the tomographic image of interest by using the reference tomographic image.

With the above-described configuration, the present exemplary embodiment can execute processing for correcting positional deviation of a tomographic image of a subject with high accuracy.

Now, a second exemplary embodiment of the present invention will be described in detail below. In the imaging apparatus 100 according to the first exemplary embodiment described above, the tomographic image capturing parameter setting unit 140 uses one B-scan image as a reference tomographic image. However, it can be useful to use a reference tomographic image including a plurality of B-scan images to improve the accuracy of correcting the positional deviation of a tomographic image. Accordingly, the present exemplary embodiment uses a reference tomographic image including a plurality of B-scan images.

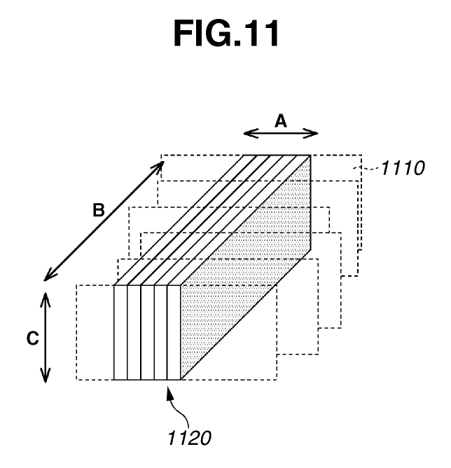

FIG. 11 illustrates an example of a positional relationship between a three-dimensional tomographic image of interest and a reference tomographic image according to the second exemplary embodiment.

Referring to FIG. 11, a three-dimensional tomographic image of interest 1110, which is illustrated in FIG. 11 as a dotted line rectangle, includes a reference tomographic image capturing range 1120. In the example illustrated in FIG. 11, the three-dimensional tomographic image of interest 1110 is a three-dimensional tomographic image of interest after being subjected to processing for correcting the positional deviation thereof in the direction of the plane of the B-scan image.

In addition, in the example illustrated in FIG. 11, sizes A, B, and C indicate a size of the reference tomographic image. More specifically, the size A indicates the size of the reference tomographic image in the main scanning direction of the three-dimensional tomographic image of interest 1110 while the size B indicates the size of the reference tomographic image in a direction intersecting the B-scan image of interest and the size C indicates the size of the reference tomographic image in the direction of depth of the B-scan image of interest.

The imaging apparatus 100 according to the present exemplary embodiment sets a parameter for capturing a reference tomographic image including a plurality of B-scan images. In addition, the imaging apparatus 100 according to the present exemplary embodiment executes processing for correcting the position of the three-dimensional tomographic image of interest by using the reference tomographic image captured according to the image capturing parameter.

An imaging system according to the present exemplary embodiment includes a configuration similar to that of the imaging system 10 according to the first exemplary embodiment illustrated in FIG. 1. The imaging apparatus 100 according to the present exemplary embodiment has a hardware configuration similar to the hardware configuration of the imaging apparatus 100 according to the first exemplary embodiment illustrated in FIG. 2.

In addition, the imaging apparatus according to the present exemplary embodiment has a functional configuration similar to that of the imaging apparatus 100-1 according to the first exemplary embodiment illustrated in FIG. 3. Furthermore, processing in a method for controlling the imaging apparatus 100 according to the present exemplary embodiment is basically similar to the processing illustrated in FIGS. 6 and 7 according to the first exemplary embodiment.

The present exemplary embodiment is similar to the first exemplary embodiment described above except the content of the processing in step S633 illustrated in FIG. 7 and the processing in step S650 illustrated in FIG. 6. In the following description, only the point of difference of the present exemplary embodiment from the above-described first exemplary embodiment will be described in detail. The description of the configuration of the present exemplary embodiment similar to that of the first exemplary embodiment described above will not be repeated in detail here.

Referring to FIG. 7, in step S633, the tomographic image capturing parameter setting unit 140 sets a parameter for capturing a reference tomographic image according to the characteristic amount extracted in step S632.

The processing in step S633 according to the present exemplary embodiment will be described in detail below. At first, the tomographic image capturing parameter setting unit 140 sets an image capturing time for capturing a reference tomographic image.

If the image capturing time is long, the amount of movement of the subject's eye 20 due to involuntary eye movement becomes large. Accordingly, it is useful to set an image capturing time as short as possible.

On the other hand, if the image capturing time is very short, sufficiently many sampling A-scans cannot be acquired. Accordingly, it is useful to determine the image capturing time considering the balance between the image capturing time and the number of sampling A-scans or the sampling density.

If the image capturing time for capturing a reference tomographic image longer than the image capturing time for capturing a three-dimensional tomographic image of interest is set, the reference tomographic image may necessarily be affected from the involuntary eye movement of the subject's eye 20 more severely than the three-dimensional tomographic image of interest may be. Accordingly, it is useful to set an image capturing time for capturing a reference tomographic image shorter than the image capturing time for capturing a three-dimensional tomographic image of interest. More specifically, it is useful to set an image capturing time for capturing a reference tomographic image having the length of time one-third or a quarter of the length of the image capturing time for capturing a three-dimensional tomographic image of interest.

In the present exemplary embodiment, the image capturing time for capturing a reference tomographic image of 0.5 seconds is set as a fixed default value. However, the present exemplary embodiment is not limited to this.

Then, the tomographic image capturing parameter setting unit 140 sets a range of capturing a reference tomographic image. More specifically, the tomographic image capturing parameter setting unit 140 sets the reference tomographic image capturing range 1120 (FIG. 11) as the range of capturing a reference tomographic image.

If the tomographic image acquisition unit 120 is a Fourier domain type tomographic image acquisition unit, the size C of the retina of the subject's eye 20 in the direction of depth thereof depends on the function of the apparatus. In other words, the size C has a fixed value in most cases.

Accordingly, in the present exemplary embodiment, the size C of the retina of the subject's eye 20 in the direction of the depth thereof is set as a fixed value of the reference tomographic image capturing range 1120. Furthermore, the sizes A and B are determined according to the size C determined as a fixed value.

It is necessary that the reference tomographic image capturing range 1120 intersects all the two-dimensional tomographic images included in the three-dimensional tomographic image of interest. Accordingly, the present exemplary embodiment sets the size B of the reference tomographic image capturing range 1120 on the retina of the subject's eye 20 as the same as the size of the three-dimensional tomographic image of interest in the direction of the Y-axis.

A reference tomographic image is affected by involuntary eye movement of the subject's eye 20 as the three-dimensional tomographic image of interest. Accordingly, the present exemplary embodiment sets the size A of the reference tomographic image capturing range 1120 to a size twice as large as the amount of positional deviation of the three-dimensional tomographic image of interest in the direction of the plane of the B-scan image.

The size A is not limited to the size twice as large as the amount of positional deviation of the three-dimensional tomographic image of interest in the direction of the Y-axis. More specifically, it is also useful if the size A larger than the amount of positional deviation is used.

It is not necessary that the reference tomographic image capturing range 1120 determined based on the sizes A and B has a rectangular shape. More specifically, the reference tomographic image capturing range 1120 can have any shape if the reference tomographic image capturing range 1120 includes a region that may include as many characteristic amounts as possible with respect to the region of the fundus whose image is to be captured.

Then, the tomographic image capturing parameter setting unit 140 sets the number of A-scans of the reference tomographic image in the main scanning direction of the three-dimensional tomographic image of interest. More specifically, in the present exemplary embodiment, a numerical value “64” is set as the number of A-scans of the reference tomographic image, which is to be used in executing pattern matching processing. The pattern matching processing will be described in detail below.

In the present exemplary embodiment, the numerical value “64” is set as the number of A-scans of the reference tomographic image for easier understanding. More specifically, the number of A-scans of the reference tomographic image is not limited to this. It is also useful if a numerical value of the number of A-scans is set at a numerical value high enough to appropriately correct the positional deviation of the three-dimensional tomographic image of interest, for example, “128” or “32”.

Suppose that the reference tomographic image is captured according to the image capturing time of 0.5 seconds. Suppose also that the maximum rate of the sampling A-scan for the tomographic image acquisition unit 120 is 60,000 A-scans/sec. In this case, 30,000 A-scans can be acquired within the image capturing time of 0.5 seconds.

In this case, the number of sampling A-scans of the three-dimensional tomographic image of interest in the direction of the Y-axis can be expressed by the following expression (4):

30,000/64=468 (4)

With respect to the reference tomographic image capturing range 1120 for capturing a reference tomographic image on the retina of the subject's eye 20, the present exemplary embodiment sets a range including as many characteristic amounts as possible among regions of the three-dimensional tomographic image of interest.

In addition, a region that can be set according to the size of the region set in the above-described manner within the region three-dimensional tomographic image of interest is set as a candidate of the region.

To paraphrase this, if N candidates of image capturing region of the reference tomographic image exist within the region of the three-dimensional tomographic image of interest, then an image capturing region u of the reference tomographic image having the total number M( ) as the largest number of characteristic amounts can be calculated by using the following expression (5):

$$M ( u ) = {arg max}_{n = 0}^{N - 1} ( {( {\sum }_{i , j , k} g ( i , j , k ) )}_{n} ) \qquad ( 5 )$$

where “u” and “n” denote one region candidate among N region candidates, “(i, j, k)” denotes the position of all pixels existing within a region candidate n, and “g(i, j, k)” denotes the characteristic amount expressed by the above-described expression (2).

In the present exemplary embodiment, the region candidate u is a region candidate including the largest number of characteristic amounts. In this case, the present exemplary embodiment sets the region candidate u as the reference tomographic image capturing range 1120.

Then, the tomographic image capturing parameter setting unit 140 sets the main scanning direction in capturing a reference tomographic image. More specifically, the tomographic image capturing parameter setting unit 140 sets the main scanning direction in capturing a reference tomographic image in the same direction as the main scanning direction for scanning the three-dimensional tomographic image of interest or a direction intersecting the B-scan image included in the three-dimensional tomographic image of interest.

It is useful to set the main scanning direction in capturing a reference tomographic image according to the method of correcting the positional deviation of the three-dimensional tomographic image of interest or in the direction in which the influence from the involuntary eye movement may be reduced.

As described above, it is not difficult to correct the positional deviation of a three-dimensional tomographic image in the direction of the plane of a B-scan image. On the other hand, it is difficult to correct the positional deviation among B-scan images. Accordingly, it is useful to employ a configuration with which the influence from the positional deviation among B-scan images is reduced.

In the present exemplary embodiment, it is supposed that the main scanning direction in capturing a reference tomographic image is set in the same direction as the main scanning direction of the three-dimensional tomographic image of interest. However, the present exemplary embodiment is not limited to this.

If the above-described sampling rate is used in the present exemplary embodiment, a reference tomographic image includes 468 B-scan images (B-scan two-dimensional tomographic images). In this case, one B-scan tomographic image includes 64 A-scans.

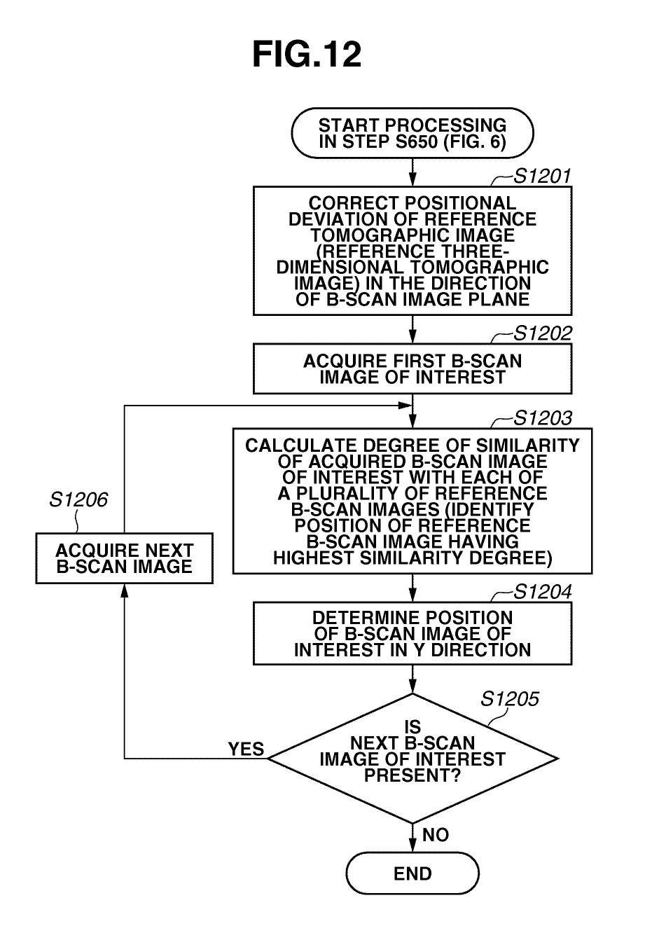

Now, the processing in step S650 illustrated in FIG. 6 will be described in detail below with reference to FIG. 12. FIG. 12 is a flow chart illustrating an example of processing for correcting positional deviation of a tomographic image of interest, which is executed in step S650 illustrated in FIG. 6, according to the present exemplary embodiment.

Referring to FIG. 12, in step S1201, the tomographic image main scanning direction position correction unit 161 corrects the positional deviation of the reference tomographic image (reference three-dimensional tomographic image) in the direction of the plane of the B-scan image. The method for correcting the positional deviation of the reference tomographic image in the direction of the plane of the B-scan image is the same as the method implemented in step S631 illustrated in FIG. 7 in the first exemplary embodiment described above. Accordingly, the description thereof will not be repeated here.

In step S1202, the tomographic image sub-scanning direction position correction unit 162 reads a XZ-corrected three-dimensional tomographic image of interest, which is a three-dimensional tomographic image of interest 1110 illustrated in FIG. 11, from the storage unit 150. In addition, the tomographic image sub-scanning direction position correction unit 162 acquires the first B-scan image of interest b(k) from the three-dimensional tomographic image of interest 1110. In processing beyond step S1202, the tomographic image sub-scanning direction position correction unit 162 executes processing for aligning the position of the B-scan image of interest acquired in the above-described manner and the position of the reference tomographic image.

In step S1203, the tomographic image sub-scanning direction position correction unit 162 determines an ROI based on the B-scan image of interest currently processed. In addition, the tomographic image sub-scanning direction position correction unit 162 identifies a position R(k) of the reference B-scan image having the ROI and a highest similarity degree among those of the reference tomographic images in the direction of the Y-axis.

In the present exemplary embodiment, the degree of similarity is determined according to a result of calculation of an SSD, which is calculated by using the expression (1) described above, on the ROI of the B-scan image of interest and on the ROI of the reference tomographic image.

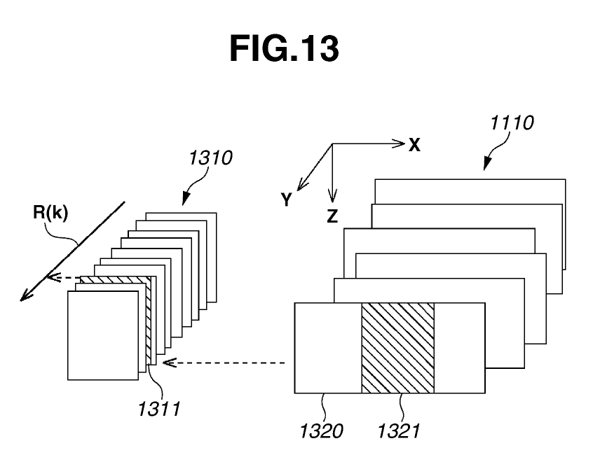

FIG. 13 illustrates an example of a result of the processing in step S650 illustrated in FIG. 6 according to the present exemplary embodiment.

The position R(k), which has been identified in step S1203, is a position of a reference B-scan image 1311 having a degree of similarity to an ROI 1321 of the k-th B-scan image 1320 of the three-dimensional tomographic image of interest 1110 highest of reference tomographic images 1310. Information about the position R(k) is stored on a memory (not illustrated) of the tomographic image sub-scanning direction position correction unit 162.

In determining the ROI based on the B-scan image of interest currently processed, the present exemplary embodiment sets the same size as that of the reference B-scan image. It is also useful if the size of the ROI is changed in order to reduce the influence from the movement of the eyeball of the subject's eye 20.

In step S1204, the tomographic image sub-scanning direction position correction unit 162 determines the position of the B-scan image of interest currently processed according to the position R(k) of the reference tomographic image in the direction of the Y-axis, which has been acquired in step S1203. Furthermore, the tomographic image sub-scanning direction position correction unit 162 executes the correction processing according to the position determined in the above-described manner.

More specifically, the tomographic image sub-scanning direction position correction unit 162 sets the position R(k) as the position of the k-th three-dimensional tomographic image of interest in the direction of the Y-axis. Furthermore, the tomographic image sub-scanning direction position correction unit 162 transmits the position R(k) to the storage unit 150 together with the positional information in the directions of the X-axis and the Z-axis acquired in step S631.

In step S1205, the tomographic image sub-scanning direction position correction unit 162 determines whether a B-scan image of interest of the three-dimensional tomographic image of interest to be subsequently processed exits (i.e., whether a B-scan image of interest that has not been subjected to the processing for correcting the positional deviation in the direction of the Y-axis exists).

If it is determined that a B-scan image of interest to be subsequently processed exists (YES in step S1205), then the processing advances to step S1206. In step S1206, the tomographic image sub-scanning direction position correction unit 162 acquires the B-scan image of interest to be subsequently processed from the storage unit 150.

Then, the processing returns to step S1203. In step S1203, the tomographic image sub-scanning direction position correction unit 162 sets the B-scan image of interest to be subsequently processed, which has been acquired in step S1206, as a B-scan image of interest to be processed. Then, the tomographic image sub-scanning direction position correction unit 162 executes the processing in step S1203 and beyond.

On the other hand, if it is determined that no B-scan image of interest to be subsequently processed exists (NO in step S1205), then the processing in the flow chart of FIG. 12 ends. By executing the processing illustrated in FIG. 12, the processing in step S650 illustrated in FIG. 6 according to the present exemplary embodiment is implemented.

In the present exemplary embodiment, a region including a large number of characteristic amounts is extracted from the three-dimensional tomographic image of interest by using the characteristic amount of the image, which is acquired based on the amount of variation of contrast of the tomographic image. However, the present invention is not limited to this. More specifically, it is also useful if a spatial frequency or an edge is used as the characteristic amount of the tomographic image.

As described above, in the present exemplary embodiment, a reference tomographic image including a plurality of B-scan images having a number of characteristic amounts large enough to appropriately align the position of the tomographic image according to a result of analysis of the tomographic image of interest. In addition, the present exemplary embodiment having the configuration described above corrects the positional deviation of the tomographic image of interest by using the reference tomographic image captured in the above-described manner.

With the above-described configuration, the present exemplary embodiment can correct the positional deviation of a tomographic image of a subject with high accuracy.

Now, a third exemplary embodiment of the present invention will be described in detail below. In the above-described first and second exemplary embodiments of the present invention, the imaging apparatus 100 extracts a region including a large number of characteristic amounts from a three-dimensional tomographic image of interest by using an image characteristic amount that is acquired based on the contrast variation amount of the tomographic image. However, the present invention is not limited to the above-described image characteristic amount.

In the present exemplary embodiment, the imaging apparatus 100 uses an image of a blood vessel included in a tomographic image as a characteristic. Thus, the imaging apparatus 100 according to the present exemplary embodiment extracts a region of a position at which a large number of blood vessel images are included in the three-dimensional tomographic image of interest based on the blood vessel image.

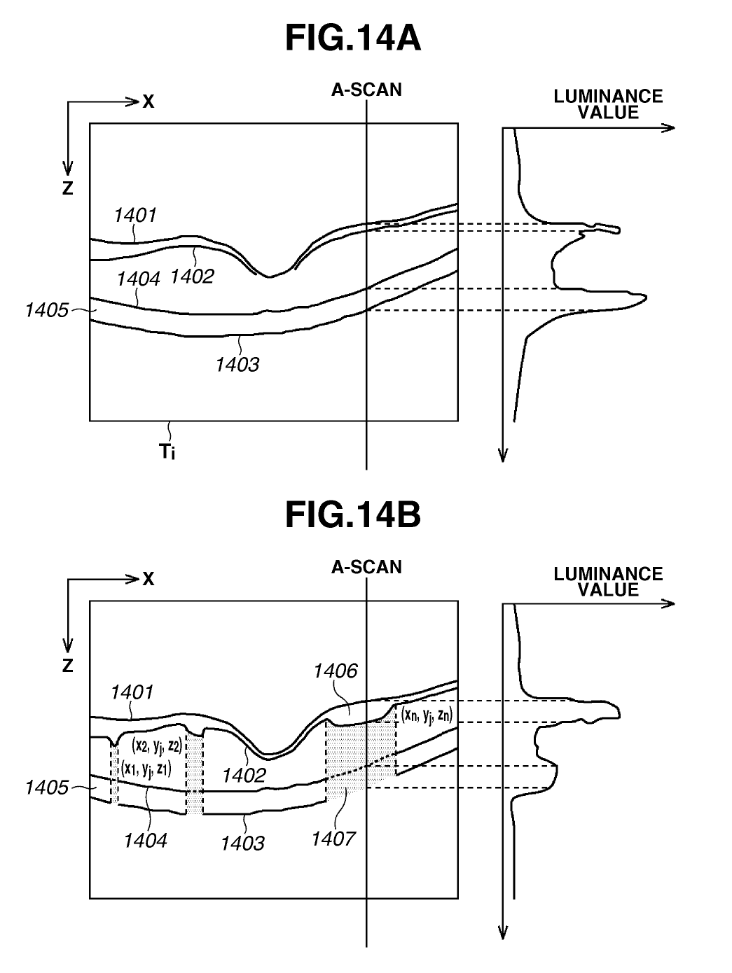

FIGS. 14A and 14B illustrate an example of a blood vessel image (characteristic) in a tomographic image according to the present exemplary embodiment. More specifically, FIG. 14A illustrates an example of a luminance value of a two-dimensional tomographic image Ti along an A-scan at a position at which no blood vessel image exists. In addition, FIG. 14B illustrates an example of a luminance value of a two-dimensional tomographic image Tj along an A-scan at a position at which a blood vessel image exists.

In the present exemplary embodiment, the two-dimensional tomographic images Ti and Tj include an inner limiting membrane 1401, a nerve fiber layer boundary 1402, a pigmented layer of retina 1403, a visual cell inner/outer segments junction 1404, and a visual cell layer 1405. In addition, the two-dimensional tomographic image Tj includes a blood vessel region 1406 and a sub-blood vessel region 1407.

Referring to FIG. 14B, in the sub-blood vessel region 1407, just like in a shadow of a blood vessel, the luminance value becomes low for the entire region and the contrast in relation to the luminance value of surrounding regions may be increased. Accordingly, it is useful to use the sub-blood vessel region 1407 in identifying the same position of the three-dimensional tomographic image of interest as the corresponding position of the reference tomographic image.

More specifically, in the present exemplary embodiment, the amount of variation of contrast of the sub-blood vessel region 1407 and that of adjacent regions (surrounding regions) is used in aligning the positions of the three-dimensional tomographic image of interest and the reference tomographic image. Accordingly, the present exemplary embodiment sets an image capturing parameter for capturing a reference tomographic image at a position at which a large number of blood vessels exist.

An imaging system according to the present exemplary embodiment has a configuration similar to that of the imaging system 10 according to the first exemplary embodiment illustrated in FIG. 1. In addition, an imaging apparatus according to the present exemplary embodiment has a hardware configuration similar to that of the imaging apparatus 100 according to the first exemplary embodiment illustrated in FIG. 2.

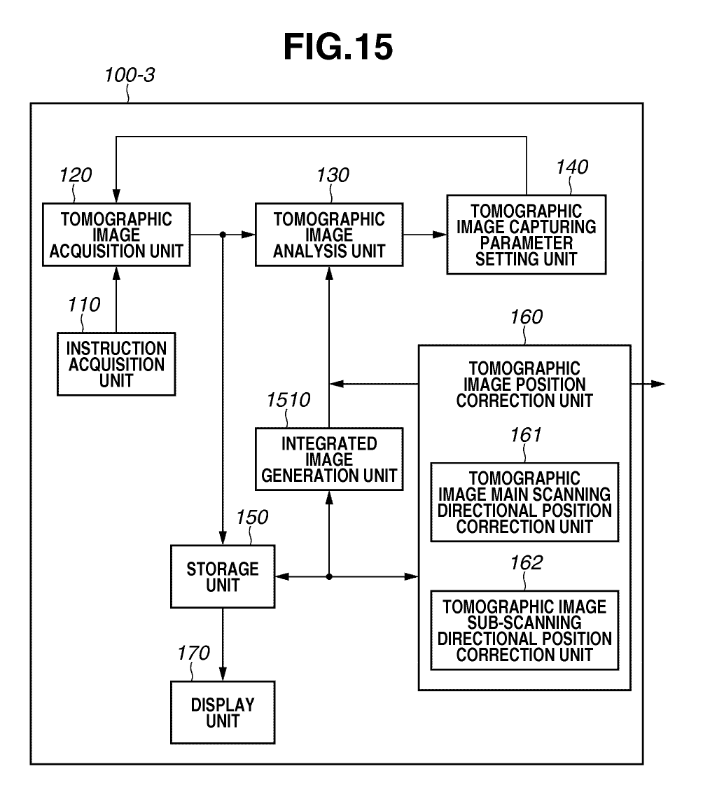

Now, an exemplary functional configuration of the imaging apparatus 100 according to the present exemplary embodiment will be described in detail below with reference to FIG. 15. FIG. 15 illustrates an exemplary functional configuration of the imaging apparatus 100 according to the present exemplary embodiment.

In the following description, the imaging apparatus 100 according to the present exemplary embodiment illustrated in FIG. 15 is described as an imaging apparatus 100-3. In the exemplary functional configuration illustrated in FIG. 15, units and components of the imaging apparatus 100-3 similar to those of the imaging apparatus 100 illustrated in FIG. 3 in the first exemplary embodiment are provided with the same reference numerals and symbols as described above in the above-described first exemplary embodiment. Accordingly, the description thereof will not be repeated here.

Referring to FIG. 15, the imaging apparatus 100-3 according to the present exemplary embodiment includes an integrated image generation unit 1510 in addition to the functional configuration of the imaging apparatus 100-1 according to the first exemplary embodiment described above with reference to FIG. 3.

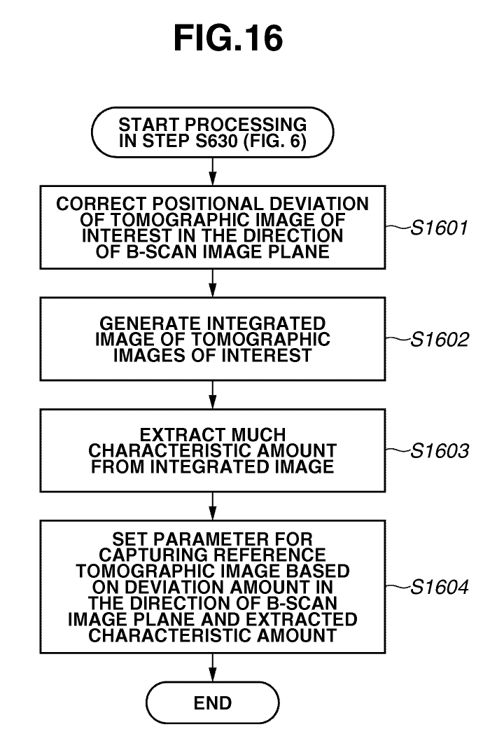

In the present exemplary embodiment, the integrated image generation unit 1510 illustrated in FIG. 15 is implemented by a program stored on the CPU 101 (FIG. 2) or the external storage device 104 (FIG. 2). A function of the integrated image generation unit 1510 of the imaging apparatus 100-3 illustrated in FIG. 15 will be described in detail below with reference to the flow chart of FIG. 16.

Processing implemented by a method for controlling the imaging apparatus 100 according to the present exemplary embodiment is similar to that illustrated in FIG. 6 except that in the present exemplary embodiment, the content of processing in step S630 illustrated in FIG. 6 is different from the content of that described above in the first exemplary embodiment. In the present exemplary embodiment, the difference point from the first exemplary embodiment only will be described in detail.

FIG. 16 is a flow chart illustrating an example of processing for setting a reference tomographic image capturing parameter, which is executed in step S630 illustrated in FIG. 6, according to the present exemplary embodiment.

Referring to FIG. 16, in step S1601, the tomographic image main scanning direction position correction unit 161, similar to the processing in step S631 illustrated in FIG. 7, corrects the positional deviation of the B-scan images of the tomographic image of interest (three-dimensional tomographic image of interest) captured and acquired by the tomographic image acquisition unit 120 in the directions of the X-axis and the Z-axis.

Furthermore, the tomographic image main scanning direction position correction unit 161 outputs the tomographic image of interest (three-dimensional tomographic image of interest) whose positional deviation in the main scanning direction has been corrected to the tomographic image analysis unit 130 and the storage unit 150.

In step S1602, the integrated image generation unit 1510 executes processing for generating an integrated image, which is generated by integrating n B-scan images of the tomographic image of interest captured by the tomographic image acquisition unit 120 in step S620 in the direction of the Z-axis (a first direction).

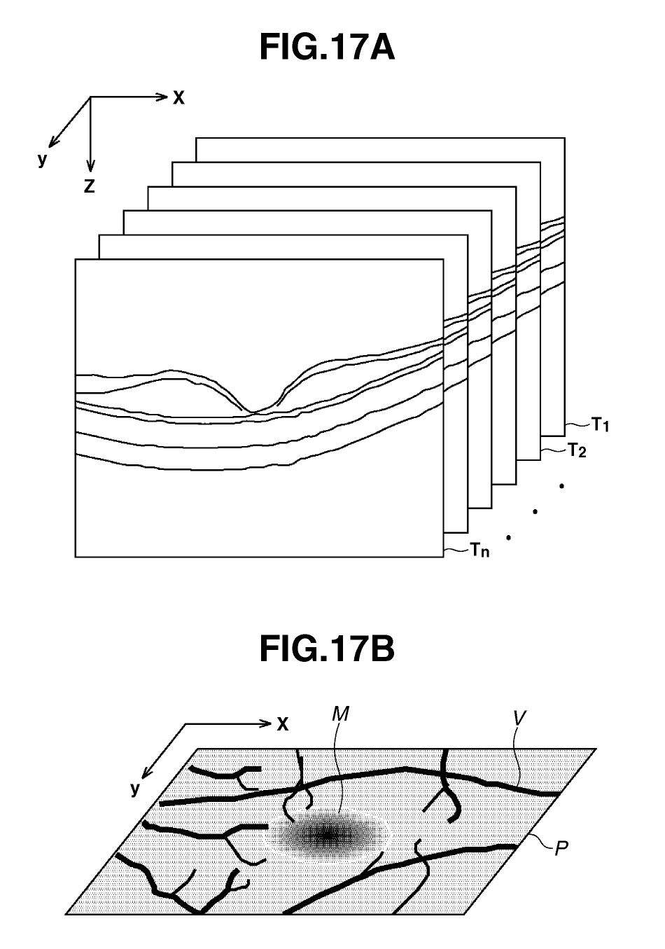

FIGS. 17A and 17B illustrate an example of a tomographic image of interest and an integrated image according to the present exemplary embodiment. More specifically, FIG. 17A illustrates tomographic images of interest T₁ through Tₙ of a yellow spot of the subject's eye 20. On the other hand, FIG. 17B illustrates an integrated image P, which is generated based on the tomographic images of interest T₁ through Tₙ.

In the present exemplary embodiment, a “direction of depth” denotes a direction of the Z-axis illustrated in FIG. 17A. Furthermore, to “integrate in the direction of depth” refers to processing for adding the luminance values at positions of depth in the direction of the Z-axis in the example illustrated in FIG. 17A.

It is also useful if the integrated image P illustrated in FIG. 17B is generated based on a value calculated by simply adding the luminance values at the positions of depth. Furthermore, it is also useful if the integrated image P illustrated in FIG. 17B is generated based on a value calculated by dividing a value calculated by addition by the number of luminance values added in the addition operation.

It is not necessary in generating the integrated image P to add the luminance values of all the pixels in the direction of depth. More specifically, it is also useful if the luminance values of an arbitrary range are added. In other words, it is also useful if, after previously examining the entire retina, the luminance values of positions within the retina only are added. Furthermore, it is also useful if the luminance values of arbitrary retina layers of the retina only.

In the present exemplary embodiment, the integrated image generation unit 1510 executes integration processing in the direction of depth (i.e., in the direction of the Z-axis) on each of the n tomographic images T₁ through Tₙ of the tomographic image of interest captured by the tomographic image acquisition unit 120.

For the integrated image P illustrated in FIG. 17B, the luminance value becomes higher as the integrated value becomes larger while the luminance value becomes lower as the integrated value becomes lower. In the integrated image P illustrated in FIG. 17B, a curve V indicates a blood vessel image. A circle M at the center of the image indicates a yellow spot of the subject's eye 20.

In the present exemplary embodiment, the tomographic image acquisition unit 120 receives reflection light of the light emitted from the low coherence light source 123 by using a light receiving element (the one-dimensional light sensor array 128). Accordingly, the tomographic image acquisition unit 120 captures and acquires the tomographic images of interest T₁ through Tₙ of the subject's eye 20.

At a position at which a blood vessel exists, the intensity of the reflection light at a position in a deeper portion of the subject's eye 20 than the blood vessel may easily become less intense. Accordingly, a value calculated by integration in the direction of the Z-axis may become smaller than that at a position at which no blood vessel exists.

Accordingly, by generating an integrated image P, the present exemplary embodiment can generate an image having a contrast between a position at which a blood vessel exists and positions other than the position at which the blood vessel exists.

Referring back to FIG. 16, after completing the processing in step S1602, the processing advances to step S1603. In step S1603, the tomographic image analysis unit 130 executes processing for extracting a region including a blood vessel, which is a characteristic amount, from the integrated image generated in step S1602.

In the present exemplary embodiment, it is useful to use an image processing method described in Elisa Ricci, Renzo Perfetti, “Retinal Blood Vessel Segmentation Using Line Operators and Support Vector Classification”, IEEE Transactions on Medical Imaging, Vol. 26, No. 10, pp. 1357-1365, 2007 or M. E. Martinez-Perez et al, “Segmentation of blood vessels from red-free and fluorescent retinal images”, Medical Image Analysis, pp. 47-61, 2007, as the method for extracting a blood vessel portion. However, the method for extracting a blood vessel portion is not limited to the above-described two methods. More specifically, it is also useful if a plurality of methods can be used in combination as the blood vessel portion extraction method.

In step S1604, the tomographic image capturing parameter setting unit 140 sets an image capturing parameter for capturing a reference tomographic image according to a result of extraction of a region including a blood vessel, which is a characteristic amount extracted in step S1603. More specifically, in step S1604, the tomographic image capturing parameter setting unit 140 sets an image capturing parameter for capturing a reference tomographic image by using a tomographic image including a largest number of blood vessel images in reference tomographic image candidates as in step S633 in FIG. 7.

After completing the processing in step S1604, the processing illustrated in the flow chart of FIG. 16 (i.e., the processing in step S630 in FIG. 6) ends.

According to the present exemplary embodiment having the above-described configuration, it is enabled to utilize a shadow image of a blood vessel, which has been captured as a tomographic image of interest, as the characteristic amount. In addition, in the present exemplary embodiment, a reference tomographic image capturing parameter for capturing a number of images including blood vessel images as large as possible is set. Accordingly, the present exemplary embodiment can capture a reference tomographic image having a high contrast.

Furthermore, the present exemplary embodiment corrects the positional deviation of the tomographic image of interest by using the reference tomographic image. Accordingly, the present exemplary embodiment can correct the positional deviation of a tomographic image of the subject with high accuracy.

Now, a fourth exemplary embodiment of the present invention will be described in detail below. In the second exemplary embodiment of the present invention described above, the tomographic image sub-scanning direction position correction unit 162 uses a reference tomographic image including a plurality of B-scan images to execute correction of the positional deviation of the three-dimensional tomographic image of interest (the processing illustrated in FIG. 12).

In this case, if involuntary eye movement of the subject's eye 20 occurs during an operation for capturing a reference tomographic image, then relative positional deviation among reference B-scan images may occur.

The present exemplary embodiment implements a method for reducing the influence from the relative positional deviation among a plurality of B-scan images included in a reference tomographic image to correct the positional deviation of the tomographic image of interest (three-dimensional tomographic image of interest).

An imaging system according to the present exemplary embodiment is similar to that of the imaging system 10 according to the first exemplary embodiment illustrated in FIG. 1. In addition, an imaging apparatus according to the present exemplary embodiment has a hardware configuration similar to that of the imaging apparatus 100 according to the first exemplary embodiment illustrated in FIG. 2.

In addition, the imaging apparatus according to the present exemplary embodiment has a functional configuration similar to that of the imaging apparatus 100-3 according to the third exemplary embodiment illustrated in FIG. 15. Furthermore, processing in the method for controlling the imaging apparatus 100 according to the present exemplary embodiment is basically similar to the processing illustrated in FIG. 6 according to the first exemplary embodiment.

The present exemplary embodiment is similar to the first exemplary embodiment described above except the content of the processing in step S650 illustrated in FIG. 6. In the following description, the point of difference of the present exemplary embodiment from the above-described first exemplary embodiment will only be described in detail.

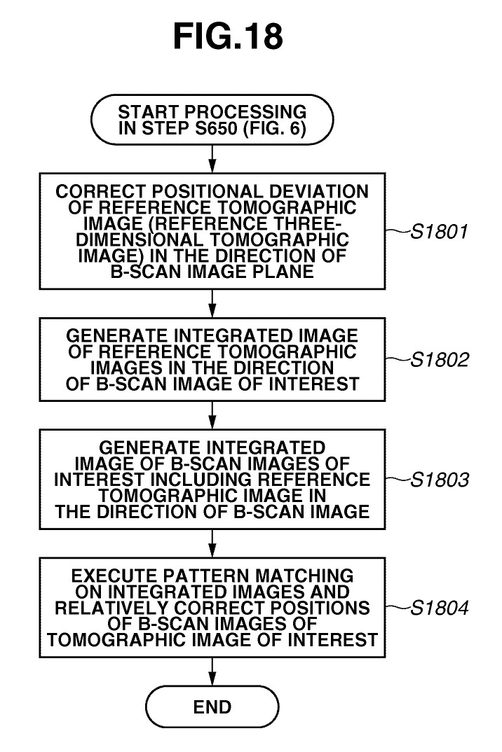

FIG. 18 is a flow chart illustrating an example of processing for correcting positional deviation of a tomographic image of interest, which is executed in step S650 illustrated in FIG. 6, according to the present exemplary embodiment.

Referring to FIG. 18, in step S1801, the tomographic image main scanning direction position correction unit 161 corrects the positional deviation of the reference tomographic image in the direction of the plane of the B-scan image (in the directions of the X-axis and the Z-axis) as in step S631 illustrated in FIG. 7.

In step S1802, the integrated image generation unit 1510 executes processing for generating an integrated image of the reference tomographic images captured by the tomographic image acquisition unit 120 in step S640.

More specifically, in step S1802, the integrated image generation unit 1510 generates an integrated image (a second integrated image) generated by integrating the reference tomographic images in the same direction as the in the direction of the X-axis (a second direction) of the tomographic image of interest instead of generating an integrated image by integrating the reference tomographic images in the direction of depth (a first direction) of the tomographic image as in step S1602.

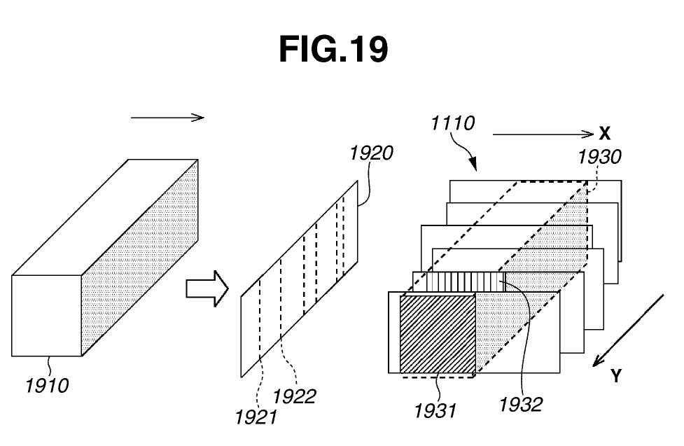

FIG. 19 illustrates an example of a result of the processing in step S650 illustrated in FIG. 6 according to the present exemplary embodiment. An example illustrated in FIG. 19 illustrates a reference tomographic image 1910 and an integrated image 1920 of the three-dimensional tomographic image of interest 1110, which is generated by integration in the direction of the X-axis.

In step S1803, the integrated image generation unit 1510 executes processing for generating an integrated image of the three-dimensional tomographic image for the same region as that of the reference tomographic image.

More specifically, in step S1803, the integrated image generation unit 1510 generates an integrated image (a first integrated image) of the three-dimensional tomographic image by executing integration of the B-scan images of interests in the direction of the X-axis (a second direction) instead of executing integration in the direction of depth (a first direction) of the tomographic image as in step S1802.

The region of the B-scan images of interest integrated in step S1803 is a region in which the reference tomographic image has been captured. More specifically, by describing the region with reference to FIG. 19, the three-dimensional tomographic image of interest 1110 is an XZ-corrected three-dimensional tomographic image of interest. A region 1930 indicates an image capturing region of a reference tomographic image 1910.

Furthermore, each of regions 1931 and 1932 is a region in common with the reference tomographic image 1910 of different B-scan image of interests. In addition, in step S1803 the common region is integrated in the direction of the X-axis of the B-scan image.

A position 1921 of the integrated image 1920 is an integrated one-dimensional vector of a region 1931 of the B-scan image of interest. A position 1922 of the integrated image 1920 is an integrated one-dimensional vector of a region 1932 of the B-scan image of interest. More specifically, each of the positions 1921 and 1922 indicates a position at which the degree of similarity of the one-dimensional vectors of the integrated image 1920 of the reference tomographic image becomes highest.

The above-described processing is executed on all B-scan images of interests of the three-dimensional tomographic image of interest. By executing the B-scan image of interest in the direction of the X-axis, a one-dimensional vector in the direction of the Z-axis, like an A-scan, can be acquired.

In step S1804, the tomographic image position correction unit 160 compares the integrated image of the B-scan image of interest generated in step S1803 with the integrated image of the reference tomographic image generated in step S1802 to execute pattern matching processing on the integrated images.

More specifically, the tomographic image position correction unit 160 compares the one-dimensional vector in the direction of the Z-axis, which is the integrated image of the B-scan image of interest, with the one-dimensional vector in the direction of the Z-axis, which is the integrated image of the reference tomographic image. In this manner, the tomographic image position correction unit 160 searches for a one-dimensional vector having the highest degree of similarity among those of the integrated image of the reference tomographic image. It is useful to use a publicly known method to calculate the degree of similarity.

In the present exemplary embodiment, the position of the one-dimensional vector of the integrated image of the reference tomographic image having the highest degree of similarity to the one-dimensional vector of the integrated image of the B-scan image of interest in the direction of the Y-axis is set as the position of the B-scan image of interest in the direction of the Y-axis.

The tomographic image position correction unit 160 (the tomographic image sub-scanning direction position correction unit 162) executes the above-described processing on all the B-scan images of the three-dimensional tomographic image of interest. Thus, the tomographic image position correction unit 160 (the tomographic image sub-scanning direction position correction unit 162) corrects the positional deviation among the B-scan images (B-scan images of interest) of the three-dimensional tomographic image of interest.

The tomographic image position correction unit 160 transmits the positionally corrected tomographic image of interest (the three-dimensional tomographic image of interest) to the storage unit 150 or an external apparatus. By executing the processing illustrated in FIG. 18, the processing in step S650 illustrated in FIG. 6 according to the present exemplary embodiment is implemented.

According to the present exemplary embodiment, if a plurality of B-scan images included in the reference tomographic image has been captured in a direction intersecting the B-scan image of interest, the relative positional deviation among the B-scan image of interests can be corrected by using the integrated image of the reference B-scan images.

With the above-described configuration, the present exemplary embodiment can reduce the influence from the positional deviation among reference B-scan images in correcting the positional deviation of the three-dimensional tomographic image of interest. Furthermore, the present exemplary embodiment having the above-described configuration can correct the positional deviation of the tomographic image of the subject with high accuracy.

Now, a fifth exemplary embodiment of the present invention will be described in detail below. In each exemplary embodiment described above, in extracting a region including a large number of characteristic amounts from a three-dimensional tomographic image of interest, the amount of variation of contrast within the three-dimensional tomographic image of interest (a blood vessel image) is extracted.

However, it can be more useful if an image characteristic amount, which is acquired from a lesion portion, such as a white spot, is used in correcting the position of a three-dimensional tomographic image of interest than using an image characteristic amount, such as variation of contrast caused by a blood vessel image included in the tomographic image.

However, a white spot is less easy to be visualized in an integrated image of a tomographic image in the direction of depth than a blood vessel is. Accordingly, in the present exemplary embodiment, the position of a lesion such as a white spot is identified by using a fundus wide area image, which is widely used in examining and searching for a lesion such as a white spot. Furthermore, the present exemplary embodiment uses a result of the lesion position identification processing to extract a region including a large number of characteristic amounts from a three-dimensional tomographic image. In the present exemplary embodiment, a white spot is described as an example of a lesion.

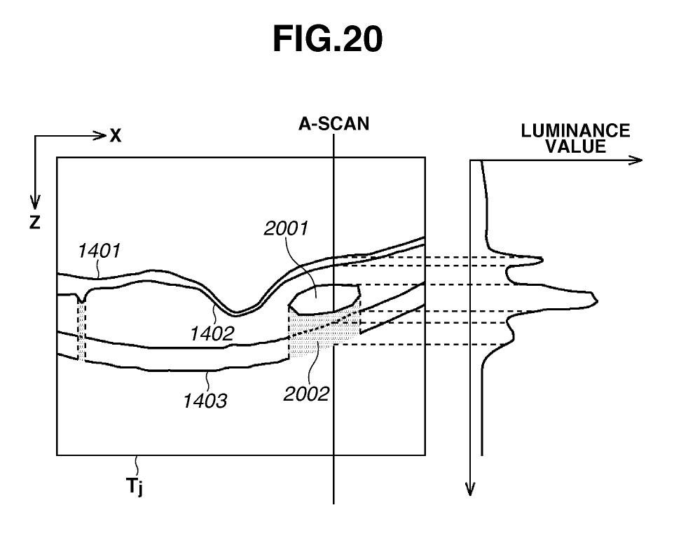

FIG. 20 illustrates an example of a leukopathy (white spot) image (characteristic) in a tomographic image according to the present exemplary embodiment.

An example illustrated in FIG. 20 includes a B-scan image (two-dimensional tomographic image) Tj in a left portion thereof while an example of the luminance value of the two-dimensional tomographic image Tj acquired along the A-scan at a position at which a white spot exists is illustrated in a right portion thereof.

In other words, in the right portion of the example illustrated in FIG. 20, an exemplary relationship between the coordinates on a line indicating an A-scan of the two-dimensional tomographic image Tj and the luminance value thereof is illustrated.

In the present exemplary embodiment, the two-dimensional tomographic image Tj includes an inner limiting membrane 1401, a nerve fiber layer boundary 1402, a pigmented layer of retina 1403, a white spot region 2001, and a sub-white spot region 2002.

In the example illustrated in FIG. 20, a white spot has been captured in the two-dimensional tomographic image (two-dimensional tomographic image) Tj. A white spot generally has a luminance value higher than that of surrounding regions. In addition, a white spot generally has a massive block-like shape. A white spot image has the above-described characteristics.

An imaging system according to the present exemplary embodiment has a configuration similar to that of the imaging system 10 according to the first exemplary embodiment illustrated in FIG. 1. In addition, an imaging apparatus according to the present exemplary embodiment has a hardware configuration similar to that of the imaging apparatus 100 according to the first exemplary embodiment illustrated in FIG. 2.

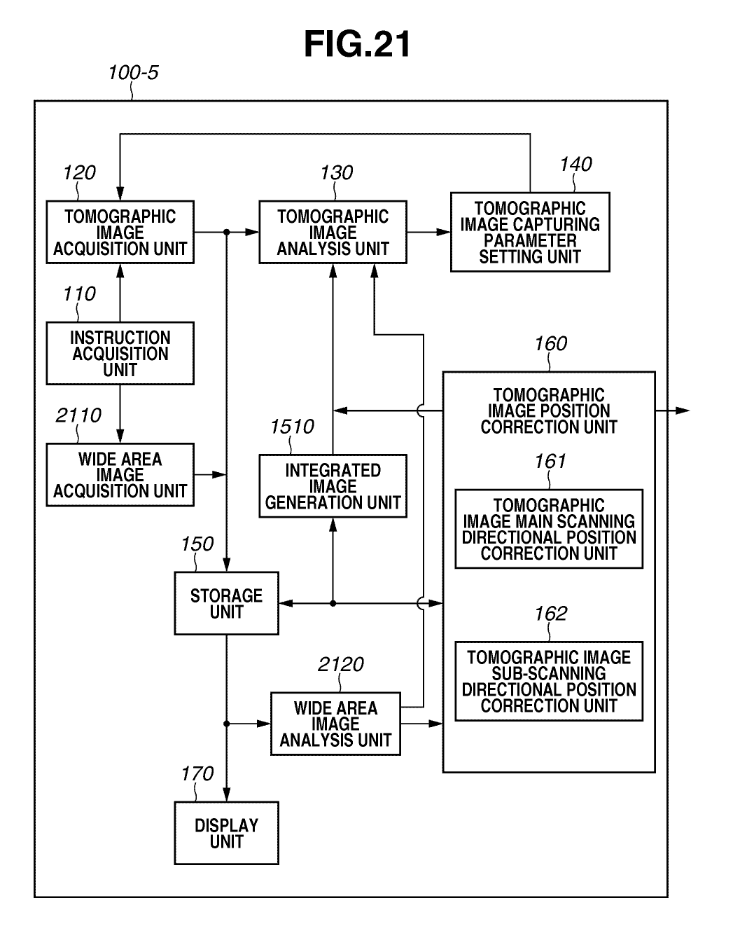

Now, an exemplary functional configuration of the imaging apparatus 100 according to the present exemplary embodiment will be described in detail below with reference to FIG. 21. FIG. 21 illustrates an exemplary functional configuration of the imaging apparatus 100 according to the present exemplary embodiment.

In the following description, the imaging apparatus 100 according to the present exemplary embodiment illustrated in FIG. 21 is described as an imaging apparatus 100-5. In the exemplary functional configuration illustrated in FIG. 21, units and components of the imaging apparatus 100-5 similar to those of the imaging apparatus 100 illustrated in FIG. 15 in the third exemplary embodiment are provided with the same reference numerals and symbols as described above in the above-described third exemplary embodiment. Accordingly, the description thereof will not be repeated here.

Referring to FIG. 21, the imaging apparatus 100-5 according to the present exemplary embodiment includes a wide area image acquisition unit 2110 and a wide area image analysis unit 2120 in addition to the functional configuration of the imaging apparatus 100-3 according to the third exemplary embodiment described above with reference to FIG. 15.

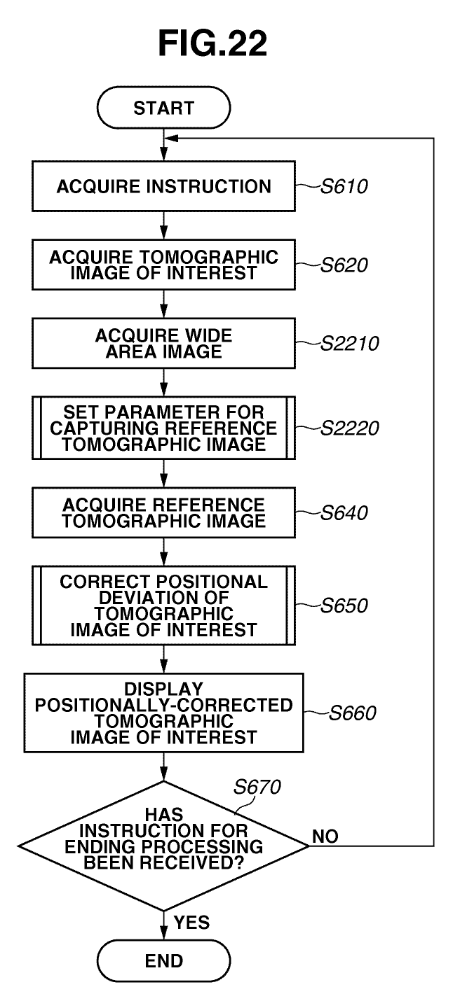

In the present exemplary embodiment, the wide area image acquisition unit 2110 illustrated in FIG. 21 is implemented by a program stored on the CPU 101 (FIG. 2), the external storage device 104 (FIG. 2), or the imaging unit 105 (FIG. 2). Functions of the wide area image acquisition unit 2110 and the wide area image analysis unit 2120 of the imaging apparatus 100-5 illustrated in FIG. 21 will be described in detail below with reference to the flow chart of FIG. 22.

Now, exemplary processing for controlling the imaging apparatus 100 (the imaging apparatus 100-5) according to the present exemplary embodiment will be described in detail below with reference to FIG. 22. FIG. 22 is a flowchart illustrating an example of processing executed in a control method for controlling the imaging apparatus 100 according to the present exemplary embodiment.

In the flow chart illustrated in FIG. 22, each step similar to step of processing in the flow chart of FIG. 6 is provided with the same step number.

Referring to FIG. 22, in step S610, the instruction acquisition unit 110 acquires information about an instruction for capturing a tomographic image of interest of a subject (the fundus of the subject person) (the subject's eye), which has been input by the operator.

In step S620, the tomographic image acquisition unit 120 executes processing for capturing a tomographic image of interest (three-dimensional tomographic image of interest) by capturing a three-dimensional tomographic image of the retina of the subject's eye according to the tomographic image capturing instruction (image capturing parameter) acquired by the instruction acquisition unit 110.

In addition, in step S620, the tomographic image acquisition unit 120 outputs the acquired tomographic image of interest to the storage unit 150 and the tomographic image analysis unit 130.

In step S2210, the wide area image acquisition unit 2110 executes processing for acquiring a wide area image by capturing a two-dimensional image of the fundus image of the subject's eye (an image capturing parameter) according to the instruction for capturing a wide area image, which has been acquired by the instruction acquisition unit 110.

Furthermore, the wide area image acquisition unit 2110 outputs the acquired wide area image to the storage unit 150. The wide area image acquisition unit 2110 includes an imaging unit configured to capture a wide area image of the fundus of the eyeball of the subject person. More specifically, the wide area image acquisition unit 2110 includes a fundus camera and a scanning laser opthalmoscope (SLO).

In step S2220, the wide area image analysis unit 2120, the tomographic image position correction unit 160, and the tomographic image analysis unit 130 execute predetermined processing.

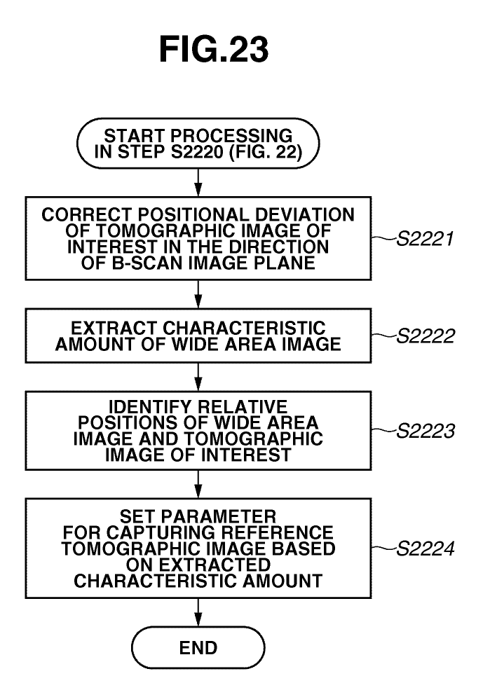

Then, the tomographic image capturing parameter setting unit 140 executes processing for setting a reference tomographic image capturing parameter. In the present exemplary embodiment, a reference tomographic image capturing parameter is set for capturing a reference tomographic image optimum for correcting positional deviation of the tomographic image of interest acquired in step S620. In step S2220, processing described below with reference to FIG. 23 is executed.

Subsequently, the present exemplary embodiment executes the processing in steps S640 through S670 as in the processing illustrated in FIG. 6. Then the processing in the flow chart of FIG. 22 ends.

Now, the processing in step S2220 illustrated in FIG. 22 will be described in detail below with reference to FIG. 23. FIG. 23 is a flow chart illustrating an example of processing for setting a reference tomographic image capturing parameter, which is executed in step S2220 illustrated in FIG. 22, according to the present exemplary embodiment.

Referring to FIG. 23, in step S2221, the tomographic image main scanning direction position correction unit 161, similar to the processing in step S631 illustrated in FIG. 7, corrects the positional deviation of the B-scan images of the tomographic image of interest (three-dimensional tomographic image of interest) captured and acquired by the tomographic image acquisition unit 120 in the directions of the X-axis and the Z-axis.

Furthermore, the tomographic image main scanning direction position correction unit 161 outputs the tomographic image of interest (three-dimensional tomographic image of interest) whose positional deviation in the main scanning direction has been corrected to the tomographic image analysis unit 130 and the storage unit 150.

In step S2222, the wide area image analysis unit 2120 reads the wide area image of the fundus acquired in step S2210 from the storage unit 150. In addition, the wide area image analysis unit 2120 executes analysis processing on the wide area image. Furthermore, the wide area image analysis unit 2120 executes processing for extracting a characteristic amount of the wide area image according to a result of the analysis on the wide area image.

In the present exemplary embodiment, an image of a lesion such as a white spot captured in the wide area image (the position of the lesion) is extracted as the characteristic amount. With respect to the method for extracting the white spot, an image processing method described in M. Niemeijer et al, “Automated Detection and Differentiation of Drusen, Exudates, and Cotton-Wool Spots in Digital Color Fundus Photographs for Diabetic Retinopathy Diagnosis”, Investigative Opthalmology & Visual Science, Vol. 48, No. 5, pp. 2260-2267, 2007 can be used to execute the extraction processing.

In step S2223, the tomographic image analysis unit 130 (or the tomographic image position correction unit 160) aligns the position of the wide area image with the position of the tomographic image of interest to identify the position of the characteristic amount (white spot) of the wide area image extracted in step S2222 on the tomographic image of interest.

Furthermore, the tomographic image analysis unit 130 extracts a white spot region that is the same for both the integrated image, which is acquired by integrating the tomographic image of interest in the direction of depth, and the wide area image as the characteristic amount. In addition, the tomographic image analysis unit 130 identifies the position of the region of cross section of the tomographic image equivalent to the white spot of the wide area image according to the white spot region. In the above-described processing, the tomographic image analysis unit 130 uses a pattern matching method in calculating the same white spot region.

In step S2224, the tomographic image capturing parameter setting unit 140 sets a parameter for capturing a reference tomographic image according to information about the position of the white spot in the tomographic image of interest, which has been acquired in step S2223.

In the present exemplary embodiment, similar to the processing in step S633 in the second exemplary embodiment described above, the tomographic image capturing parameter setting unit 140 uses information about the image capturing parameter for capturing a tomographic image including a largest number of characteristic amounts (white spot images) of candidates of the reference tomographic image to set the reference tomographic image capturing parameter.

After completely executing the processing in step S2224, then the processing in the flow chart of FIG. 23 (i.e., the processing in step S2220 illustrated in FIG. 22) ends.

As described above, the present exemplary embodiment having the above-described configuration sets the reference tomographic image capturing parameter for correcting the positional deviation of the tomographic image according to a result of the analysis on the wide area image. Accordingly, the present exemplary embodiment can acquire a reference tomographic image including characteristic amounts of the number large enough to appropriately align the position of the tomographic image of interest.

In addition, the present exemplary embodiment correct the positional deviation of the tomographic image of interest by using the reference tomographic image. With the above-described configuration, the present exemplary embodiment can correct the positional deviation of the tomographic image of the subject with high accuracy.

The imaging apparatus 100 according to each exemplary embodiment of the present invention executes analysis on the tomographic image or the fundus wide area image. In addition, in each exemplary embodiment of the present invention, the imaging apparatus 100 uses the characteristic amount acquired based on a result of the analysis to extract a region including a large number of characteristic amounts from the three-dimensional tomographic image of interest. Furthermore, the imaging apparatus 100 according to each exemplary embodiment of the present invention sets a reference tomographic image capturing parameter according to the result of the extraction. However, the present invention is not limited to this.

It is also useful if the tomographic image capturing parameter setting unit 140 sets the reference tomographic image capturing parameter, such as the position of capturing the image, according to various information, such as history information about the subject's eye, information about a region of capturing the image, or information about the current status of the lesion of the subject's eye, which has been acquired by a subject eye information acquisition unit (not illustrated).

It is also useful if the tomographic image capturing parameter setting unit 140 sets the reference tomographic image capturing parameter according to the reference tomographic image capturing parameter input and instructed by the operator via the instruction acquisition unit 110.

In addition, it is also useful if the following configuration is employed. More specifically, the reference tomographic image capturing parameter, which has been set by the tomographic image capturing parameter setting unit 140 according to the result of analysis on the three-dimensional tomographic image of interest, on the display unit 170 before actually capturing a reference tomographic image. In this case, the tomographic image capturing parameter setting unit 140 modifies the image capturing parameter according to an input or an instruction by the operator.

With the above-described configuration, each exemplary embodiment of the present invention can set the reference tomographic image capturing parameter for correcting the positional deviation of the three-dimensional tomographic image of interest according to an input or instruction by the operator.

In addition, the present exemplary embodiment having the above-described configuration can capture a reference tomographic image including a characteristic useful in aligning the position of the three-dimensional tomographic image of interest. With the above-described configuration, the present exemplary embodiment can correct the positional deviation of the three-dimensional tomographic image of interest with high accuracy.

In extracting a characteristic amount from the tomographic image of interest by using the tomographic image analysis unit 130, it is also useful if the tomographic image analysis unit 130 extracts a characteristic amount including at least one of the spatial frequency, the contrast variation amount, the edge intensity, whether a blood vessel image is included in the tomographic image, and whether a lesion image is included in the tomographic image, with respect to the tomographic image of interest.

In setting an image capturing parameter by using the tomographic image capturing parameter setting unit 140, it is also useful if the tomographic image capturing parameter setting unit 140 sets at least one of the reference tomographic image capturing range, the speed and the direction of scanning for the image capturing operation, and the sampling density to be used in the image capturing operation.

Each step of the processing of the method for controlling the imaging apparatus 100 according to each exemplary embodiment of the present invention, which is illustrated in FIGS. 6, 7, 9, 12, 16, 18, 22, and 23, can be implemented by the CPU 101 of a computer by loading and executing a program from a storage medium, such as the external storage device 104. The program and a computer-readable recording medium (storage medium) that records (stores) the program can implement the present invention.

The present invention can be implemented in a system, an apparatus, a method, a program, or a storage medium storing the program, for example. More specifically, the present invention can be applied to a system including a plurality of devices and to an apparatus that includes one device.

The present invention can also be implemented by directly or remotely supplying a program of software implementing functions of the above-described exemplary embodiments (in the exemplary embodiments, the program corresponding to the processing performed according to the flow charts in FIGS. 6, 7, 9, 12, 16, 18, 22, and 23) to a system or an apparatus and reading and executing supplied program codes with the system or a computer of the apparatus.

Accordingly, the program code itself, which is installed (i.e., stored) in the computer for implementing the functional processing of the present invention with the computer, implements the present invention. That is, the present invention also includes the computer program implementing the functional processing of the present invention.

Accordingly, the program can be configured in any form, such as object code, a program executed by an interpreter, and script data supplied to an operating system (OS).

As the recording medium for supplying such program code, a floppy disk, a hard disk, an optical disk, a magneto-optical disk (MO), a compact disc-read only memory (CD-ROM), a CD-recordable (CD-R), a CD-rewritable (CD-RW), a magnetic tape, a nonvolatile memory card, a ROM, and a digital versatile disc (DVD) (a DVD-read only memory (DVD-ROM) and a DVD-recordable (DVD-R)), for example, can be used.

The above program can also be supplied by connecting to a web site on the Internet by using a browser of a client computer and by downloading the program from the web site to a recording medium such as a hard disk. In addition, the above program can also be supplied by downloading a compressed file that includes an automatic installation function from the web site to a recording medium such as a hard disk. The functions of the above embodiments can also be implemented by dividing the program code into a plurality of files and downloading each divided file from different web sites. That is, a World Wide Web (WWW) server for allowing a plurality of users to download the program file for implementing the functional processing configures the present invention.

In addition, the above program can also be supplied by distributing a storage medium such as a CD-ROM and the like which stores the program according to the present invention after an encryption thereof; by allowing the user who is qualified for a prescribed condition to download key information for decoding the encryption from the web site via the Internet; and by executing and installing in the computer the encrypted program code by using the key information.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of the embodiment of the present invention, after the program code read from the recording medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-162964 filed Jul. 9, 2009, which is hereby incorporated by reference herein in its entirety.

What is claimed is:

1. An imaging apparatus configured to capture a tomographic image of a subject, the imaging apparatus comprising:
a first tomographic image acquisition unit configured to acquire a first tomographic image of the subject;
a tomographic image analysis unit configured to analyze the first tomographic image;
an image capturing parameter setting unit configured to set an image capturing parameter for capturing a second tomographic image of the subject according to a result of analysis by the tomographic image analysis unit;
a second tomographic image acquisition unit configured to acquire the second tomographic image captured according to the image capturing parameter set by the image capturing parameter setting unit; and
a correction unit configured to correct positional deviation of the first tomographic image by using the second tomographic image.

2. The imaging apparatus according to claim 1, wherein the first tomographic image acquisition unit and the second tomographic image acquisition unit constitute a same tomographic image acquisition unit.

3. The imaging apparatus according to claim 1, wherein the tomographic image analysis unit is configured to analyze the first tomographic image to extract a characteristic amount of the first tomographic image, and
wherein the image capturing parameter setting unit is configured to set the image capturing parameter according to a result of extraction of the characteristic amount executed by the tomographic image analysis unit.

4. The imaging apparatus according to claim 3, wherein the characteristic amount extracted by the tomographic image analysis unit includes at least one of a spatial frequency, an amount of variation of a contrast, an edge intensity, whether a blood vessel image is included, and whether a lesion image is included, with respect to the first tomographic image.

5. The imaging apparatus according to claim 1, wherein the image capturing parameter setting unit is configured to set, as the image capturing parameter, at least one of a range of capturing the second tomographic image, a speed and a direction of scanning executed in capturing the second tomographic image, and a sampling density used in capturing the second tomographic image.

6. The imaging apparatus according to claim 3, further comprising an integrated image generation unit configured to generate an integrated image by integrating the first tomographic image in a first direction,
wherein the tomographic image analysis unit is configured to extract the characteristic amount from the integrated image.

7. The imaging apparatus according to claim 6, further comprising:
a wide area image acquisition unit configured to acquire a wide area image of the subject; and
a wide area image analysis unit configured to analyze the wide area image,
wherein the tomographic image analysis unit is configured to extract the characteristic amount from the integrated image according to a result of analysis by the wide area image analysis unit.

8. The imaging apparatus according to claim 7, wherein the wide area image analysis unit is configured to execute analysis processing for extracting a position at which a lesion included in the wide area image exists.

9. The imaging apparatus according to claim 1, further comprising an integrated image generation unit configured to generate a first integrated image by integrating the first tomographic image in a second direction and to generate a second integrated image by integrating the second tomographic image in the second direction,
wherein the correction unit is configured to correct positional deviation of the first integrated image according to the first integrated image and the second integrated image.

10. The imaging apparatus according to claim 1, further comprising:
a display unit configured to display the image capturing parameter set by the image capturing parameter setting unit; and
an instruction acquisition unit configured to acquire an input instruction given by an operator of the imaging apparatus,
wherein the image capturing parameter is able to be modified according to the input instruction acquired by the instruction acquisition unit.

11. The imaging apparatus according to claim 1, wherein the correction unit includes a sub-scanning direction position correction unit configured to correct positional deviation of the first tomographic image in capturing the first tomographic image in a sub-scanning direction by using the second tomographic image and a main scanning direction position correction unit configured to correct positional deviation of the first tomographic image in capturing the first tomographic image in a main scanning direction.

12. The imaging apparatus according to claim 1, wherein the second tomographic image acquisition unit is configured to acquire at least one tomographic image of the subject as the second tomographic image.

13. The imaging apparatus according to claim 1, wherein the subject is a subject's eye.

14. A method for controlling an imaging apparatus configured to capture a tomographic image of a subject, the method comprising:
acquiring a first tomographic image of the subject;
analyzing the first tomographic image and obtaining an analysis result;
setting an image capturing parameter for capturing a second tomographic image of the subject according to the analysis result;
acquiring the second tomographic image captured according to the set image capturing parameter; and
correcting positional deviation of the first tomographic image by using the second tomographic image.

15. A computer-readable storage medium storing instructions which, when executed by a computer, cause the computer to perform operations comprising:
acquiring a first tomographic image of the subject;
analyzing the first tomographic image and obtaining an analysis result;
setting an image capturing parameter for capturing a second tomographic image of the subject according to the analysis result;
acquiring the second tomographic image captured according to the set image capturing parameter; and
correcting positional deviation of the first tomographic image by using the second tomographic image.
